(19) United States
(12) Patent Application Publication
(10) Pub. No.: US 2025/0075341 A1
(43) Pub. Date: Mar. 6, 2025

(54) METHOD AND APPARATUS FOR MAKING CARBON NANOMATERIALS USING A LOW-LITHIUM ELECTROLYTE

(71) Applicant: C2CNT LLC, Venice, FL (US)

(72) Inventors: Gad Licht, Venice, FL (US); Stuart Licht, Venice, FL (US)

(21) Appl. No.: 18/742,822

(22) Filed: Jun. 13, 2024

Related U.S. Application Data
(60) Provisional application No. 63/580,235, filed on Sep. 1, 2023.

(51) Int. Cl. C25B 1/135; C25D 9/08; C25D 21/02

(52) U.S. Cl. CPC C25B 1/135; C25D 9/08; C25D 21/02

(57) ABSTRACT

The embodiments of the present disclosure relate to a method and apparatus for producing a GNC product that may comprise carbon nanotubes (CNTs). The method and apparatus employ carbon dioxide (CO₂) and a carbonate electrolyte that is low in lithium as reactants in an electrolysis reaction in order to make CNTs. In some embodiments of the present disclosure, the low lithium reactant is strontium carbonate, or a graphene-defect agent may be introduced into the electrolysis reaction.

### TECHNICAL FIELD

This disclosure generally relates to production of carbon nanomaterials. In particular, the disclosure relates to methods and apparatus for producing carbon nanomaterials using low-lithium electrolytes.

### BACKGROUND

Graphene nanocarbons (GNCs) are carbon nanomaterials with various shapes that retain the fundamental structure of graphene. Graphene is a two-dimensional, honeycomb-structured material formed by a single layer of sp² hybrid orbital carbon atoms with a thickness of about 0.335 nm, which corresponds to the thickness of one carbon atom. The graphene structure imparts remarkably high strength, and conductivity as well as solid lubricant, electronic, medical and catalytic activity properties. These properties may be accentuated or modified by building the graphene structure into different shapes (e.g., wrapping and stacking). GNCs have various morphologies including a single planar layer that is referred to as graphene, and multiple layered graphene, which are carbon nano-platelets. Both are 2D (two dimensional, planar symmetry) materials. The 0D graphene structure (with point symmetry) consists of concentric layer spheres of one or more spheres of graphene, and includes either solid (carbon nano-onion), or hollow (hollow carbon nano-onion) morphologies. Rather than being formed into a sphere, the graphene plane can be wrapped as a cylinder, and one or more concentric cylinders can then combine to form a carbon nanotube. The cylindrical, walled carbon nanotube structure further reinforces the high strength of graphene. Carbon nanotubes (CNTs) have the highest measured tensile strength (strength 93,900 MPa) of any material. Multi-walled CNTs consist of concentric walls of cylindrical graphene sheets. Concentric cylinders are examples of 1D (linear) symmetry. Nano-scaffolds are an example of 3D GNCs in which multilayered graphene is stacked at sharp angles in an open structure.

CNTs have many useful properties including high electrical-conductivity, high thermal-conductivity, flexibility, and they can be chemically modified. The implication of these useful properties is that CNTs have had a steady rise in their applications. For example, low (typically much less than 1%) concentrations of CNTs in structural materials can increase the strength of a range of structural materials such as cement, steel, and aluminum. Because each of these materials can have a high carbon-footprint, a carbon composite with increased strength that requires less material may dramatically decrease the carbon-footprint.

A known process by which CNTs are produced is chemical vapor deposition (CVD). However, CVD of CNTs is expensive and has a high carbon-footprint.

In addition to chemical vapor deposition (CVD), electrolysis reactions that use carbon dioxide (CO₂) and a lithium-carbonate electrolyte are also known processes for making CNTs. These electrolysis reactions may employ electrolysis potentials of less than 1 volt for splitting CO₂ in molten lithium-carbonate solutions to produce uniform CNTs and a carbon nanofiber product at high coulombic efficiency. The CO₂ from the atmosphere can be directly converted to CNTs, as confirmed by isotope (¹³C) tracking. The electrolytic splitting of CO₂ in molten lithium-carbonate can occur as direct carbon capture and conversion from the air without CO₂ pre-concentration, or with exhaust gas CO₂, or with concentrated CO₂.

These known electrolysis reactions have typically demonstrated when using carbonate electrolytes that include lithium such as pure molten lithium carbonate (Li₂CO₃, with a melting point of about 723° C.), or an electrolyte with a substantial fraction of Li₂CO₃ mixed with other carbonates such as sodium carbonate (Na₂CO₃), potassium carbonate (K₂CO₃), magnesium carbonate (MgCO₃), calcium carbonate (CaCO₃), barium carbonate (BaCO₃) or Li₂CO₃ mixed with other salts including oxides, borates, sulfates, phosphates or nitrates. It was generally assumed that lithium cations might be a necessary component to make CNTs using molten carbonates and CO₂ in an electrolysis reaction. However, the cost of lithium generally results in a high cost of operating these electrolytic reactions and, therefore, further methods and systems for producing graphitic carbon nanomaterials are desirable.

Li₂CO₃ is expensive, and this is in part due to the competitive demand of Li₂CO₃, in particular for use in the preparation of Li-ion batteries for the growing electronic vehicle (EV) market. Global Li₂CO₃ prices in 2022 to 2023 have increased and vacillated in the range of $25,000 to $75,000 per tonne. These elevated prices present a cost constraint to the alternative use of Li₂CO₃ as a molten electrolyte in the electrolytic transformation of Li₂CO₃ to GNCs. Alternatively, Na₂CO₃ and K₂CO₃ are available at a much lower global cost of less than $2,000 per tonne. However, even low-level additions of these alternative carbonates, to replace some of the Li₂CO₃, substantially disfigures the morphology of the GNCs.

### SUMMARY

The embodiments of the present disclosure relate to an electrolysis method and electrolytic cell apparatus and system for producing a graphene nanocarbon (GNC) product that comprises various nanostructures, including carbon nanotubes (CNTs). The method and apparatus employ CO₂ as a reactant in an electrolysis reaction in order to make the GNC product and uses an electrolyte that replaces a large fraction of the lithium carbonate (Li₂CO₃) with a low-lithium carbonate electrolyte as an alternative salt. As a result, there is a lower amount of lithium used in the electrolysis reaction to make the GNC product, which in turn can reduce the costs associated with using electrolyte mixtures that have a higher lithium content.

In some embodiments of the present disclosure, the electrolyte mixture is a binary mixture of lithium carbonate and an alternative salt, such as but not limited to: a strontium salt, a beryllium salt, a radium salt or any combination thereof. In some embodiments of the present disclosure, the electrolyte is a binary mixture of lithium carbonate and strontium carbonate. In some embodiments of the present disclosure, the electrolyte is a binary mixture of lithium carbonate and strontium oxide.

In some embodiments of the present disclosure, the electrolyte mixture is a binary mixture of lithium carbonate and strontium borate. In some embodiments of the present disclosure, the electrolyte is a ternary mixture of lithium carbonate with a strontium salt and another salt. In some embodiments of the present disclosure, the electrolyte mixture comprises—in addition to lithium carbonate and strontium carbonate—Group 1 or Group 2 salts including beryllium salts, alkali and alkali earth oxides, their peroxides and superoxide salts, and the other Group 5, 6, or 7 alkali and alkali earth salts, such as borates, sulfates, nitrates, phosphates, halides, halates, and perhalates. In other embodiments of the present disclosure, the electrolyte mixture contains strontium carbonate and either sodium carbonate or barium carbonate. In some embodiments of the present disclosure, the electrolyte is a mixture of three or more components. The embodiments of the present disclosure can cost substantially less than those electrolysis reactions that use an electrolyte that contains primarily or only lithium carbonate.

Some embodiments of the present disclosure relate to a method for making a GNC product. The method comprises the steps of: heating a low-lithium carbonate electrolyte to obtain a molten carbonate electrolyte; positioning the molten carbonate electrolyte between an anode and a cathode in an electrolytic cell; applying an electrical current to the cathode and the anode in the electrolytic cell; and, collecting a carbon nanomaterial (GNC) product from the cathode.

In some embodiments of the present disclosure, the step of employing one or more non-lithium GNC facilitation elements may refer to either adding one or more further chemical constituents, or to altering one or more reaction conditions, or operational conditions, to modify the electrical current, or both of adding a further chemical constituent or altering one or more operational conditions of the electrolysis process.

In some embodiments of the present disclosure, the low-lithium GNC facilitation element is one or more of: (i) non-lithium or low lithium salts, including but not limited to: strontium carbonate, beryllium carbonate, sodium carbonate, calcium carbonate, barium carbonate, an oxide such as strontium oxide, barium oxide, beryllium oxide, sodium oxide, calcium oxide, iron oxide, cobalt oxide, lithium oxide, a borate or boron oxide such as strontium borate or B₂O₃, or any combination thereof (to allow carbon nanomaterials to form with less lithium present); (ii) enhancing transition metal nucleation by adding one or more transition metal nucleation agents, (iii) adding one or more defect inducing agents, (iv) reducing or removing an electrolyte conductivity impediment element, or any combinations thereof. In some embodiments, enhancing transition metal nucleation may occur by adding one or more transition metal nucleation reagents. In some embodiments, the addition of a defect inducing agents may be by the addition of one or more chemical agents that may induce tetrahedral sp³ graphene defects. Without being bound by any particular theory, induced defects in the graphene walls of the CNTs during synthesis may provide a mechanism for distinct nanographene morphologies, or by which larger cations may be used in a stable and high-yield CO₂ electrolysis process to make CNTs and other GNC products. In some embodiments, the removal of the electrolyte conductivity impediment element may refer to changing the voltage, current, and/or current density to enhance electrical conductivity.

Some embodiments of the present disclosure relate to methods for selecting one or more structures of the GNC product. For example, some embodiments of the present disclosure relate to employing one or more, specific method steps for producing GNC products that comprise a greater amount of a desired graphene structure within the GNC product. For example, the graphitic GNC product comprises a greater amount, as determined by a weight percent (wt %) or purity (% of the desired graphitic carbon nanostructures shown in an image) of the GNC product, of the following desired graphitic carbon nanostructures: a CNT, a carbon platelet structure, a graphene structure, a nano-onion structure, a nano-sphere structure, a hollow nano-sphere structure or any combinations thereof. By employing one or more, specific method steps, the GNC product can be made up of some, most, substantially all or all of the selected one or more graphitic structures, as determined by the wt % of the GNC product.

Some embodiments of the present disclosure relate to an apparatus that comprises an electrolytic cell for making one or more GNC products. An electrolytic cell for making a GNC product, the electrolytic cell comprising one or more walls that define a plenum, an anode and a cathode that are positioned within the plenum, wherein the plenum is configured to receive a low-lithium molten carbonate electrolyte between the anode and the cathode. The electrolytic cell may further be configured to receive a graphene-defect agent within the plenum, a nanomaterial selection component, and an electrical current that is applicable to the anode and the cathode to initiate an electrolysis reaction for making a GNC product.

In some embodiments of the present disclosure, the anode and cathode of the electrolytic cell are generally aligned with a horizontal plane and they are vertically spaced apart from each other.

Without being bound by any particular theory, when graphene is made it can include various defects, including intrinsic defects and extrinsic defects. Intrinsic defects may consist of non-sp² orbital hybrid carbon atoms being present in the graphene, which often results in the existence of non-hexagonal rings surrounded by hexagonal rings. Reported intrinsic defects of graphene include Stone-Wales defects, single vacancy defects, multiple vacancy defects, line defects and defects caused by the presence of carbon adatoms. Extrinsic defects may perturb the crystalline order of the graphene by including non-carbon atoms. Reported extrinsic defects of graphene include foreign adatoms and substitutional impurities.

Without being bound by any particular theory, some embodiments of the present disclosure relate to leveraging defects in the graphene of the CNT walls to allow larger cations to flow through the graphene to facilitate CNT growth during a CO₂ electrolysis reaction. Without being bound by any particular theory, any induced defects or vacancies may enhance the graphene porosity, with some embodiments of the present disclosure more specifically relating to tetrahedral sp³ graphene defects. Tetrahedral sp³ graphene defects may be induced by the presence of a graphene-defect inducing agent, such as an oxide, during a CO₂ electrolysis reaction. Graphene sheet “vacancies” are known to enhance the degree of lithium cation intercalation and to increase the capacity of lithium-cation anode battery storage. Graphene vacancies and oxide-induced defects in graphene may allow the intercalation of not only Li-cations into graphene, but also larger cations such as sodium cations, magnesium cations, calcium cations, and strontium cations. As such, induced defects in the graphene walls of the CNTs during their synthesis may provide a mechanism by which cations other than lithium may be used in a stable and high-yield CO₂ electrolysis process to make CNTs. In some embodiments of the present disclosure, introducing oxides at high concentrations may induce greater defects in the growing GNC product.

Some embodiments of the present disclosure relate to the addition of transition metal nucleating agents to a low-lithium electrolyte.

Some embodiments of the present disclosure relate to the use of low current density to control conductivity during formation of the GNC product.

Some embodiments of the present disclosure relate to a system for synthesizing a GNC product in a low-lithium environment. The system comprises a heater for heating a low-lithium carbonate electrolyte to obtain a molten low-lithium carbonate electrolyte; an electrolytic cell for receiving or housing the molten low-lithium carbonate electrolyte between an anode and a cathode in an electrolytic cell; one or more non-lithium GNC formation facilitation elements; a source of carbon dioxide; and a source of electrical current for applying electrical current to the cathode and the anode in the electrolytic cell. Without being bound by any particular theory, the systems of the present disclosure may employ the electrolytic cell apparatus described herein. Without being bound by any particular theory, the systems of the present disclosure may be configured to perform the methods described herein.

By using CO₂ from the atmosphere as a reactant in the electrolysis reactions of the present disclosure, some embodiments of the present disclosure can decrease the greenhouse gas footprint of the processes and systems that make CNTs and other GNC products. By using a low-lithium carbonate electrolyte, the costs of making valuable GNC products may be significantly reduced.

### BRIEF DESCRIPTION OF THE DRAWINGS

These and other features of the present disclosure will become more apparent in the following detailed description in which reference is made to the appended drawings.

FIG. 1 Left panel: an extracted cathode after the electrolysis of CO₂ in a pure 750° C. Li₂CO₃ electrolyte. In the middle and right panels SEM image of the washed carbon nanotube product are shown at a magnification of ×710 and ×2250, respectively.

FIG. 2 shows thermogravimetric analysis (TGA) analysis of the FIG. 1 electrolysis product.

FIG. 3 transmission electron microscope (TEM) with High Angle Annular Dark-Field (HAADF) elemental analysis imaging of the carbon nanotube product produced by the electrolysis of CO₂ in molten pure Li₂CO₃.

FIG. 4 shows scanning electron microscope (SEM) images of nanocarbon allotropes synthesized by the electrolytic splitting of CO₂ in molten carbonate. Top row (from left to right): conical CNT, nano-bamboo, nano-pearl, Ni-coated CNT, nano-flower, nano-dragon. Middle row: nano-rod, nano-belt, nano-onion, hollow nano-onion, and nano-tree. Bottom row (from left to right) Carbon nanotube, nano-scaffold, nano-platelet, graphene, nano-helices.

FIG. 5 shows Left: x-ray diffraction analysis (XRD) spectra, and right: Raman spectra of several other GNC products synthesized by the electrolytic splitting of CO₂ in pure Li₂CO₃, or Li₂CO₃ with Na₂CO₃ through variation of the electrolysis conditions.

FIG. 6 shows SEM images of the product of electrolysis in various molten 770° C. Li₂CO₃ electrolytes mixed with Na₂CO₃ or K₂CO₃. The electrolysis processes are conducted with an additional 8 wt % LiBO₂, which improves the CNT product morphology. SEM image of washed carbon nanotube product obtained panel A from Na₂CO₃ 10 wt % electrolysis A (10 μm scale bar); panel B from K₂CO₃ 20 wt % electrolysis (20 μm scale bar); panel C from Na₂CO₃ 20 wt % electrolysis (10 μm scale bar) & panel D (10 μm scale bar); panel E from Na₂CO₃ 50 wt % electrolysis (10 μm bar,) and panel F from Na₂CO₃ 60 wt % electrolysis (50 μm scale bar).

FIG. 7 shows a comparison of the carbonate to carbon dioxide and metal oxide equilibrium constants for strontium, lithium, sodium, potassium, and barium carbonate.

FIG. 8 shows SEM images of the washed carbon nanotube product of electrolysis in a 750° C. 25 wt % SrCO₃ to 75 wt % Li₂CO₃, electrolyte at 0.2 A/cm² with a stainless steel 304 anode and a brass cathode. Top row from left to right SEM magnification is 400×, 390×, 400× and 390× magnification. Bottom row from left to right SEM magnification is 5,200×, 5,400×, 10,000× and 45,000× magnification.

FIG. 9 shows SEM images of the washed carbon nanotube product of an electrolysis performed with a current density of 0.2 A/cm² in a 750° C. with a stainless steel 304 anode and a brass cathode in a strontium carbonate mixed an alkali carbonate electrolyte. Top row: in 35 wt % SrCO₃ to 65 wt % Li₂CO₃ electrolyte; from left to right SEM magnification is 460×, 5,400×, 10,500× and 19,000× magnification. Bottom row: in 33.3 wt % SrCO₃, 33.3 wt % Na₂CO₃ and 33.3 wt % Li₂CO₃ electrolyte; from left to right SEM magnification is 410×, 5,000×, 5,600× and 25,000× magnification.

FIG. 10 shows SEM images of the washed carbon nanotube product of electrolysis at 780° C. with a stainless steel 304 anode and a brass cathode in a 50 wt % strontium carbonate 50 wt % lithium carbonate electrolyte at low (0.07 A/cm² for 16 hours) or high (0.5 A/cm² for 1 hour) current density. Top row: the from left to right SEM magnification is 410×, 2,550×, 5,100× and 19,000× magnification. Bottom row: from left to right SEM magnification is 410×, 5,100×, 19,000× and 24,000× magnification.

FIG. 11 shows energy dispersive X-ray spectroscopy (EDS) images of the carbon nanotube product of electrolysis with a stainless steel 304 anode and a brass cathode in a 780° C. 50 wt % strontium carbonate 50 wt % lithium carbonate electrolyte at 0.5 A/cm² for 1 current density hour.

FIG. 12 is a line graph that depicts the electrolysis potential measured in various molten carbonate electrolytes.

FIG. 13 is a line graph that depicts the melting point and solubility of mixes of a strontium carbonate and lithium carbonate binary salt.

FIG. 14 is a line graph that depicts the equilibrium constant for various alkali and alkali earth carbonate salts.

FIG. 15 shows a line graph (Panel A) that depicts TGA results for a carbon nanotube product made with an electrolyte of strontium carbonate (25 wt %) in lithium carbonate (75 wt %) and the remaining panels show SEM images of the carbon nanotube product.

FIG. 16 shows SEM images of a carbon nanotube product made with a high current density and a strontium carbonate (45 wt %) and lithium carbonate (65 wt %) binary electrolyte.

FIG. 17 shows SEM images of a carbon nanotube product made with a strontium carbonate (50 wt %) and lithium carbonate (50 wt %) binary electrolyte.

FIG. 18 shows SEM images of a carbon nanotube product made with a strontium carbonate (60 wt %) and lithium carbonate (40 wt %) binary electrolyte.

FIG. 19 shows a graphene nanocarbon product made with a strontium carbonate (64 wt %), lithium carbonate (35 wt %) and strontium oxide (1 wt %) electrolyte. Panels A and B show photographs of the product and the remaining panels show SEM images of the product.

FIG. 20 shows SEM images of a carbon nano-onion product made with a strontium carbonate (54 wt %), lithium carbonate (41 wt %) binary electrolyte and sodium carbonate (5 wt %) electrolyte.

FIG. 21 shows images of a carbon nanotube product made with a strontium carbonate (50 wt %) and lithium carbonate (50 wt %) binary electrolyte using a high current density and a large area cathode. Panels A and B show photos of the product and the remaining panels show SEM images of the product.

FIG. 22 shows images of a carbon nanostructure comprising product made with a ternary, low-lithium carbonate electrolyte that comprised strontium borate.

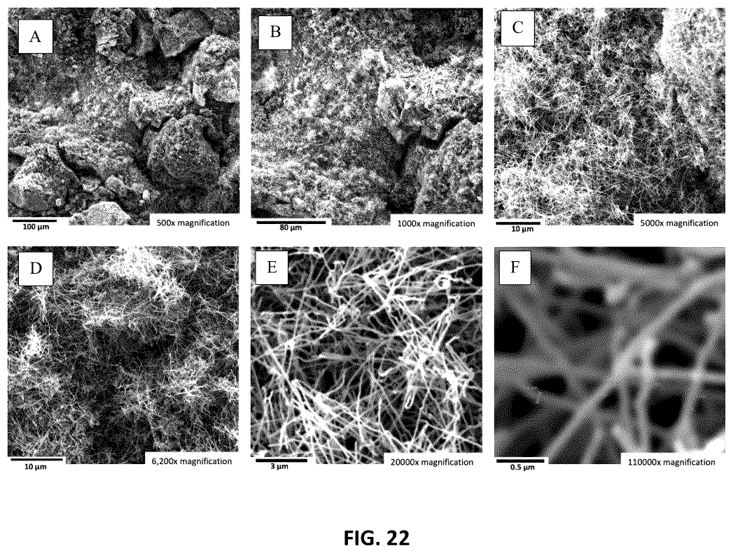

FIG. 23 shows TGA analysis of beryllium carbonate.

FIG. 24 shows TGA analysis of strontium carbonate and lithium carbonate with and without beryllium carbonate.

### DETAILED DESCRIPTION

The embodiments of the present disclosure relate to methods and apparatus for producing a graphene nanocarbon (GNC) product that comprises graphitic carbon nanostructures, such as carbon nanotubes (CNTs), carbon nano-onions (CNOs) and other carbon nanostructures. The methods and apparatus employ carbon dioxide (CO₂) as a reactant in an electrolysis reaction in order to make the GNC product. The embodiments of the present disclosure employ an electrolyte that has low-lithium, referred to herein as a low-lithium electrolyte.

Some embodiments of the present disclosure relate to methods that employ an electrolysis reaction for making a GNC product. The electrolysis reaction occurs in an environment with a molten, low-lithium electrolyte that is positioned between an anode and a cathode. Carbon is introduced into the molten electrolyte, as either pure CO₂, concentrated CO₂, CO₂ that is entrained in atmospheric air, another carbon-containing gas or other anthropogenic sources of CO₂.

Some embodiments of the present disclosure relate to an apparatus and a system that employs the apparatus. The apparatus comprises an electrolytic cell that includes an anode and a cathode. In some embodiments of the present disclosure, the anode and cathode are arranged vertically spaced apart from each other.

### Definitions

Unless defined otherwise, all technical and scientific terms used herein have the same meaning as commonly understood by one of ordinary skill in the art to which this disclosure belongs.

As used herein, the term “about” refers to an approximately +/−10% variation from a given value. It is to be understood that such a variation is always included in any given value provided herein, whether or not it is specifically referred to.

As used herein, the expression “low-lithium” means a low content of lithium such as when small amounts of lithium may be present, or when no detectable amounts of lithium are present. In some embodiment of the present disclosure, a “low-lithium carbonate electrolyte” is used to refer to a carbonate electrolyte that has less lithium present than a carbonate electrolyte that has lithium carbonate alone. For clarity the expression “low-lithium carbonate electrolyte”, is used here to refer to an electrolyte in which the lithium content is greater than about 5% on a weight basis (wt %) and less than about 100% wt % of the entire mixture. For clarity, the expressions “lithium-free carbonate electrolyte”, and “predominantly non-lithium electrolyte” are used here in to refer to an electrolyte in which there is no detectable amount of lithium or where a small amount of lithium is present when the electrolyte is a mixture and the lithium-containing component forms less than about 5% wt % of the entire mixture or less than about 4 wt %, less than about 3 wt %, less than about 2 wt %, less than about 1 wt %, less than about 0.5 wt %, less than about 0.25 wt %, less than about 0.1 wt %, less than about 0.05 wt %, or less than about 0.025 wt % or less than about 0.01 wt % of the entire mixture.

Embodiments of the present disclosure will now be described and include references to the Examples and the figures.

Some embodiments of the present disclosure relate to a method for producing a GNC product that comprises CNTs. The method comprises the steps of heating a low-lithium carbonate electrolyte to obtain a molten, low-lithium carbonate electrolyte; positioning the molten, low-lithium carbonate electrolyte between an anode and a cathode in an electrolytic cell; applying an electrical current to the cathode and the anode in the electrolytic cell; and, collecting a GNC product from the cathode. In some embodiments of the present disclosure, the method further comprises a step of employing one or more non-lithium GNC facilitation elements and/or a step of introducing a graphene-defect agent into the low-lithium carbonate electrolyte, either before the heating step or after. In some embodiments of the present disclosure, the GNC product is doped or magnetic or not.

The step of heating the low-lithium carbonate electrolyte can be achieved by various approaches, as would be appreciated by the skilled reader. For example, a heating apparatus such as an oven or furnace can be used to heat the electrolyte to a sufficient temperature so that it transitions into a molten, liquid state. As such, any heating apparatus that can achieve the temperatures required to heat the electrolyte to its melting point are contemplated herein.

In some embodiments of the present disclosure, the low-lithium electrolyte can be a binary mixture, a ternary mixture, or a mixture of more than three components. For example, the binary mixture may comprise two components selected from: lithium carbonate, and either strontium carbonate, or strontium oxide, or any other strontium salt. A ternary mixture may comprise lithium carbonates, low-lithium carbonates or oxides, and a graphene-defect agent. A more complex mixture may include substances to dope products, enhance thermal or electrical properties of electrolyte, or in other way modify the electrolyte or product.

Without being bound by any particular theory, the reduction of CO₂ in a lithiated or strontiated carbonate electrolyte is a 4e⁻ process that proceeds in accordance with Equation 1A or 1B (EQN. 1A or 1B):

Li₂CO₃(molten)+4e^{-→}C(nanomaterial;)+O₂(gas)+Li₂O(dissolved) (EQN. 1A).

SrCO₃(molten)+4e^{-→}C(nanomaterial;)+O₂(gas)+SrO(dissolved) (EQN. 1B).

Without being bound by any particular theory, CO₂ added to the electrolyte chemically reacts with lithium oxide to renew and reform Li₂CO₃ in accordance with Equation 2A or 2B (EQN. 2A or 2B):

CO₂(atmospheric or stack)+Li₂O(dissolved) [symbol] Li₂CO₃(molten) (EQN. 2A).

CO₂(atmospheric or stack)+SrO(dissolved) [symbol] SrCO₃(molten) (EQN. 2B).

Without being bound by any particular theory, when EQN. 1A or 1B is combined with EQN. 2A or 2B yields a net electrolysis reaction, in accordance with Equation 3 (EQN. 3):

CO₂(gas)+4e^{-→}C(nanomaterial)+O₂(gas) (EQN. 3).

Without being bound by any particular theory, at temperatures higher than about 800° C., a two, rather four, electron reduction can increasingly dominate, and by about 950° C., the electrolysis product is pure carbon monoxide, rather than carbon, in accordance with Equation 4 (EQN. 4):

CO₂(gas)+2e^{-→}CO(gas)+½O₂(gas) (EQN. 4).

A ternary Li, Na, and K carbonate eutectic mixture has a melting point below 400° C. The potassium component of the electrolyte has been observed to inhibit carbon nanomaterial formation and, as such, under some conditions potassium may not be a desirable component of the low-lithium carbonate electrolyte. Below about 600° C. the electrolysis reaction products in the ternary carbonate electrolyte are largely amorphous carbon and platelets arranged in a 1 to 2 μm “honeycombed” morphology. Above about 600° C. the electrolysis carbon product increasingly exhibits a mix of GNC products.

Without being bound by any particular theory, the embodiments of the present disclosure relate to electrolytes that facilitate GNC formation including: (i) low-lithium agents that include non-lithium salts including, but not limited to: strontium carbonate, beryllium carbonate, sodium carbonate, calcium carbonate, barium carbonate and oxides, such as strontium oxide, barium oxide, beryllium oxide, sodium oxide, calcium oxide, iron oxide, cobalt oxide, lithium oxide or any combination thereof (to allow carbon nanomaterials to form); (ii) molten and stable between about 700° C. and about 850° C.; (iii) able to readily dissolve oxides; and, (iv) inexpensive as compared to lithium carbonate. Strontium carbonate has a high melting point of about 1494° C. Strontium carbonate and strontium salts are an order of magnitude less expensive than lithium carbonate.

The molten electrolyte is then positioned between an anode and a cathode within an electrolytic cell. The electrolytic cell may be any type of vessel that can maintain its structural integrity in the face of the electrochemical environment that occurs during the electrolysis reactions of the present disclosure. The electrolytic cell may have one or more walls that may be made of a desired material or that are coated with a desired material that will not degrade in the environment of the electrolysis reaction. In some embodiments of the present disclosure, the electrolytic cell is made of substantially pure alumina. In some embodiments of the present disclosure, the electrolytic cell is a tubular vessel with a closed end.

In some embodiments of the present disclosure, the electrolyte mixture may be melted inside the electrolytic cell or it may be melted outside the cell and transferred thereto. Because the electrolysis reaction will typically occur over a time period whereby the molten electrolyte could cool, the electrolytic cell can be configured with its own integral heating apparatus, such as an integral heater, or it may be configured to be heated by an external heater that is external to the electrolytic cell so that the electrolyte is maintained in the molten state for the desire period of time.

In some embodiments of the present disclosure, the electrolytic cell maybe configured to maintain the electrolyte at least at about 650° C., at least at about 675° C., at least at about 700° C., at least at about 725° C., at least at about 750° C., at least at about 775° C., at least at about 800° C., at least at about 825° C., at least at about 850° C., at least at about 875° C., at least at about 900° C., at least at about 1000° C. or greater than about 1000° C.

The anode can be made of various metals or alloys. Some anodes can be made of materials that comprise nickel. Some non-limiting examples of suitable materials for the anodes of the present disclosure include: substantially pure nickel, an alloy that is comprised of substantially mostly nickel, an alloy that is comprised of some nickel. For example, stainless steel 304 or stainless steel 306 or other stainless steels, Inconel 718 or other Inconels, such as, but not limited to Inconel 600 and Inconel 625, Nichrome A (composed of about 80% nickel and about 20% chromium), Nichrome C (composed of nickel, iron and chromium), Incoloy alloy (such as Incoloy 800 composed of about 40% iron, about 30-35% nickel and about 19-23% chromium).

The anode may be planar in shape and it can be made of various dimensions. In some embodiments of the present disclosure, the anode may be made of wire that is rolled into a substantially flat coil with an upper face and a lower face. The upper and lower faces of the coiled anode may have substantially equal areas that are suitable for fitting within the electrolytic cell. In some embodiments, the coiled anode faces have an area that is between about 1 cm² and about 20 cm²; between about 2 cm² and 10 cm²; or between about 3 cm² and about 5 cm². The skilled person will appreciate that the size of the electrolytic cell may dictate the size of the coiled anode. The coiled anode may be arranged to be generally aligned with a horizontal plane. In some embodiments of the present disclosure, the walls of the electrolytic cell may be made of or lined with a material that acts as an anode.

The cathode can be made of various metals or alloys. Some cathodes can be made of materials that comprise steel, galvanized steel, copper, or any combinations thereof. Some further non-limiting examples of suitable materials for the cathodes of the present disclosure include: copper alloys such as Monel, Cu₂O₂, and Cu7O8, bronze and brass, such as Muntz Brass.

The cathode may be planar in shape and can be made of various dimensions. In some embodiments of the present disclosure, the cathode may be made of wire that is rolled into a flat coil with an upper face and a lower face. The upper and lower faces of the coiled cathode may have substantially equal areas that are suitable for fitting within the electrolytic cell. In some embodiments, the coiled cathode faces have an area that is between about 1 cm² and about 20 cm²; between about 2 cm² and 10 cm²; or between about 3 cm² and about 5 cm². The skilled person will appreciate that the size of the electrolytic cell may dictate the size of the coiled cathode. The coiled cathode may be arranged to be generally aligned with a horizontal plane.

In some embodiments of the present disclosure, the size and orientation of the cathode can be selected to substantially mirror the size and orientation of the anode. In some embodiments of the present disclosure, the anode and the cathode may be generally aligned with a horizontal plane and vertically spaced apart from each other. As the skilled person will appreciate, the distance between the electrodes must permit the passage of sufficient electric current therebetween but the amperage of the electric current and the size of the electrolytic cell may also influence how far apart the electrodes are vertically spaced apart. In some embodiments of the present disclosure, the electrodes may be vertically spaced apart from each other by about 0.25 cm, about 0.5 cm, about. 0.75 cm, about 1 cm, about 1.25 cm, about 1.5 cm, about 1.75 cm, about 2 cm, about 3 cm, about 4 cm, about 5 cm, about 7.5 cm, about 10 cm or further.

In order to initiate and maintain the electrolysis reaction within the electrolytic cell, an electric current is supplied from a source of electric current and while the current is applied, it passes between the anode and cathode via the molten electrolyte therebetween. In some embodiments of the present disclosure, the electric current may be an alternating current or a direct current. In some embodiments of the present disclosure, the current may be between about 0.01 amps (A) and about 5 A. In some embodiments of the present disclosure, the current may be between about 0.025 A and about 4 A; between about 0.05 A and about 3 A; between about 0.075 A and about 2 A; between about 0.1 A and about 1 A. In some embodiments of the present disclosure the current is about 0.5 A.

In some embodiments of the present disclosure, the current is applied at a substantially constant current density. For example, the current density of the applied current may be between about 0.01 A/cm² and about 1 A/cm². In some embodiments of the present disclosure, the current density of the applied current may be between about 0.025 A/cm² and about 0.75 A/cm²; between about 0.05 A/cm² and about 0.5 A/cm²; between about 0.075 A/cm² and about 0.25 A/cm²; or between about 0.01 A/cm² and about 0.1 A/cm². In some embodiments of the present disclosure, the current density is about 0.1 A/cm². In some embodiments of the present disclosure, an initial lower current density is used to control conductivity during formation of the GNC product and a second higher current density is used to facilitate growth of the GNC product.

In some embodiments of the present disclosure, the method further comprises the step of employing one or more non-lithium GNC facilitation elements. In some embodiments of the present disclosure, the one or more non-lithium GNC facilitation elements may comprise: (i) adding a non-lithium salt, such as but not limited to: a strontium salt, a beryllium salt, a sodium salt, a calcium salt, a barium salt, a radium salt, (ii) enhancing transition metal nucleation, iii) adding one or more defect inducing agents, (iv) reducing or removing an electrolyte conductivity impediment element, and (v) any combination thereof.

In some embodiments of the present disclosure, the step of enhancing transition metal nucleation may comprise adding a transition metal nucleating agent to the low-lithium electrolyte, either before, during or after the heating step. In some embodiments, the transition metal oxide may be iron oxide (Fe₂O₃), chromium oxide (Cr₂O₃), or a combination thereof. In a particular embodiment, the transition metal nucleating agent is Fe₂O₃. In some embodiments, the transition metal nucleating agent may be a transition metal salt of one or more of an iron, chromium, nickel, copper, manganese, titanium, zirconium, molybdenum, tantalum, tungsten, silver, cadmium, tin, ruthenium, vanadium, or cobalt salt. In some embodiments, the transition metal nucleating agent may be a transition metal oxide.

In some embodiments of the present disclosure, the step of adding one or more defect inducing agents comprises a step of introducing a graphene-defect agent into the low-lithium carbonate electrolyte, either before, during or after the heating step. This adding step can be achieved by various approaches, depending on what the nature of the graphene-defect agent is. For example, the graphene-defect agent may be a chemical, a mechanical element, an optical element, a physical element or any combination thereof that induces graphene defects and/or graphene vacancies in graphitic structures of the GNC product. This step of introducing the graphene-defect agent into the low-lithium carbonate electrolyte can occur before, during or after the low-lithium carbonate electrolyte is heated to a molten state.

In some embodiments of the present disclosure, the graphene defects are localized within a graphene component of the graphitic carbon nanostructures within the GNC product and the defects are intrinsic, extrinsic or any combination thereof.

Examples of intrinsic graphene defects are Stone-Wales defects, single vacancy defects, multiple vacancy defects, line defects, the inclusion of carbon adatoms or any combination thereof.

Examples of extrinsic graphene-defects are the inclusion of foreign adatoms or substitutional impurities.

In adatom defects, oxygen may attach to the surface of the CNT or other carbon nanomaterials and disrupt the bonding, or may replace carbon within the carbon nanostructure itself.

In some embodiments of the present disclosure, the graphene-defect agent is an oxide. The oxide may be introduced into the low-lithium carbonate electrolyte by adding a chemical oxide, by a chemical reaction caused by a change in the temperature of the molten carbonate electrolyte, by degradation of the electrodes, by oxidation of the anode or any combination thereof.

Suitable examples of chemical oxides that may be added into the low-lithium carbonate electrolyte include, but are not limited to: an alkali oxide, an alkali earth oxide, a metal oxide, a non-metal oxide or any combination thereof. In some embodiments of the present disclosure, one or more oxides may be added to the low-carbonate electrolyte, including but not limited to: strontium oxide (SrO), sodium oxide (Na₂O), barium oxide (BaO), beryllium oxide (BeO), calcium oxide (CaO), aluminum oxide (Al₂O₃) or any combination thereof. Combinations may also be added as reorganized oxide salts, for example, without being limited to, sodium or barium aluminate. In some embodiments of the present disclosure, the oxide is one or more of barium oxide, sodium oxide or calcium oxide. In some embodiments of the present disclosure, the oxide is iron or cobalt oxide. In some embodiments of the present disclosure, the oxide is lithium oxide at about 5 percent or less concentration.

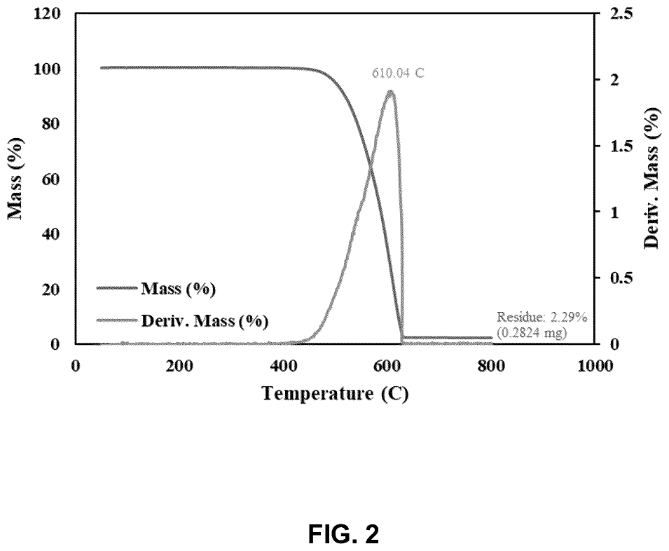

In the process of a CO₂ molten carbonate electrolysis reaction, small transition metal “seeds” have been observed at the ends of the CNT product, and it was shown that the mechanism of molten carbonate CNT growth may be activated by both tip and root transition metal nucleation processes by use of transition metals as nucleating agents. Without being bound to any particular theory, the mechanistic concept that graphene defects or vacancies may facilitate CNT growth in low-lithium molten carbonate electrolytes can be seen in FIG. 2. In FIG. 2A, the catalyst tip can move along with the CNT growth. In FIG. 2B, the catalyst is at the stationary root or base from which the CNT grows. SEM evidence of both tip and root growth CNT has been observed. FIG. 2 shows two schematics that represent proposed carbon nanotube (CNT) growth mechanisms upon a cathode during a carbon dioxide (CO₂) electrolysis reaction, wherein FIG. 2A shows a CO₂^{→}CNT+O₂ electrolysis tip growth mechanism and FIG. 2B shows CO₂^{→}CNT+O₂ a root growth mechanism. The top arrow 202 of FIG. 2A represents CO₂ dissolution reaction in molten carbonate represented by the equation: CO₂ (gas)+M₂O_{(dissolved)}→2M⁺₍ₘₒₗₜₑₙ₎+CO₃²⁻₍ₘₒₗₜₑₙ₎. The arrow 204 represents the net cathode reaction, represented by the equation: 2M⁺+CO₃²⁻+4e^{- →}C+M₂O+2O²⁻. The arrow 206 represents the net anode reaction, represented by the equation: 2O²⁻→O₂+4e⁻. For both FIG. 2A and FIG. 2B, there are sp³ oxide induced graphene defects, wherein low M=Li⁺; and high M=Li⁺ or Na⁺. For FIG. 2A, the metal catalyst 210 is at the tip of the CNT cylindrical graphene walls 208 of a carbon nanotube 210, which is above a layered graphene 218. For FIG. 2B, the metal catalyst 210 is at the bottom of the CNT cylindrical graphene walls 208 of a carbon nanotube 210, closer to the cathode 216. In both FIG. 2A and FIG. 2B, the growth direction is represented by arrow 214 and the double arrows 218 pointing upwards represent 4e⁻.

Without being bound by any particular theory, the carbonate species, generated from the continuous CO₂ renewal of the low-lithium carbonate electrolyte provide the ongoing carbon building blocks of CNT walls, and the carbonate reduction to carbon occurs at a metal catalyst interface with the growing CNT cylindrical graphene walls. However, carbonate must have easy access not only to the interface with the outer CNT walls, but also to interface with the inner CNT walls. Carbonate movement to the interior of the growing carbon nanotube may be inhibited by charge buildup. This charge buildup may be reduced if cations also have easy access to the interior walls. The lithium cation is a small cation, and requires relatively few defects or vacancies in the growing cylindrical carbon nanotube walls to access the interior regions of the CNT. However, a higher number of defects is required to facilitate ions larger than lithium cations to transfer through the CNT walls. A higher number of defects may be accomplished through the addition of a graphene-defect agent. This is, at least part of, the basis upon which the embodiments of the present disclosure were developed to grow a GNC product by CO₂ electrolysis in low-lithium carbonate electrolyte(s).

The use of an electrolyte that is a binary mixture (for example, strontium carbonate/lithium carbonate or strontium oxide/lithium carbonate), and/or an electrolyte that is a ternary mixture (for example, strontium/sodium/lithium carbonate), and/or has more components and that can provide an electrolyte melting point within the optimal range for CO₂ to carbon nanomaterial growth of between about 700° C. to about 850° C. Low-lithium electrolysis may be performed using a planar, rather than a coiled, and brass, rather than Monel, cathode without substantially affecting low-lithium CNT growth.

In the embodiments of the present disclosure, the electrolyte is a mixture of at least one non-lithium salt and optionally a lithium salt to form the low-lithium carbonate electrolyte. SrCO₃ is available at a more stable global price of approximately $1,500 per tonne; a cost that is 1 to 2 orders of magnitude less than Li₂CO₃. Strontium is the tenth most abundant metal in the earth's core, while lithium is known to be twenty-fourth most abundant. Strontium carbonate is widely mined, and refined as strontium sulfate or carbonate. Formerly, strontium carbonate was used in glass compositions for television and cathode ray devices, but is not used in today's flat screens. Today strontium is used in pyrotechnics, and applications including some ceramics, ferrite magnets, superconductors, biomaterials, chemical sensors, and catalysts. It is also used to protect certain magnesium alloys against corrosion and in specialized cement compositions.

Because strontium carbonate and strontium oxide are substantially less expensive than comparable lithium-carbonate based electrolytes and because strontium is widely available, strontium salts are suitable candidates for making a low-lithium carbonate salt. However, strontium carbonate (SrCO₃) is solid at 1494° C., which is too high for CO₂ electrolysis to synthesize solid GNC products. The inventors have demonstrated that temperatures below 800° C. are suitable for CO₂ molten carbonate electrolysis. At higher temperatures, carbon monoxide gas increasingly forms, and the product is pure carbon monoxide gas by 950° C. Carbon monoxide is not preferred as a decomposition product because its main use is as an oxidant, and in that use the carbon monoxide returns CO₂ to the atmosphere. Alternatively, GNCs retain the high (geologic stability) of the mineral graphite to sequester the CO₂.

Beryllium carbonate (BeCO₃) is another non-lithium salt that can be used to make a low-lithium carbonate electrolyte mixture that is useful with the embodiments of the present disclosure. Beryllium carbonate has anomalous physical chemical characteristics compared to the alkali and alkali earth carbonates, both in its very low 54° C. melting point, and its release of CO₂ to form beryllium oxide, beryllium carbonate only loosely binds carbon dioxide. At room temperature beryllium carbonate (solid BeCO₃) is often stored under a blanket of CO₂ gas to prevent its decomposition), beryllium oxide is the lightest weight oxide (other than water), and lithium and beryllium oxide have among the highest carbon capture storage capacities (as moles CO₂ storable per kg oxide), in the reverse equilibrium of EQN 5, for example with M as Be or Li:

CO₂+MO [symbol] MCO₃ (EQN. 5)

It was observed that beryllium oxide or beryllium carbonate can substantially decrease the melting point of strontium carbonate mixes or other alkali or alkali earth carbonates used alone or in combination. As one example, a eutectic mix of lithium, sodium and potassium carbonate is known to have a very low melting point (compared to the minimum melting point of over 700° C. of their pure carbonates) of approximately 394 to 399° C., which can be lowered by the addition beryllium carbonate or beryllium oxide.

In some embodiments of the present disclosure, the GNC product made according to the methods, apparatus and systems described herein above, may result in a doped GNC product. Without being bound by any particular theory, if a doping component, also referred to as a dopant, is introduced into the method, apparatus or system, then atoms of the dopant may be directly incorporated into various of the graphitic structures of the GNC product. When atoms of the doping component are directly introduced into the GNC product, as it is being built in situ upon the cathode, the resulting doped GNC product has desired chemical physical properties that are different than a GNC product (a non-doped GNC product) that does not include atoms of the doping component. Without being bound by any particular theory, the doping component may include at least one material with a group IIIA element, a non-carbon group IVA element, a group VA element, a group VIA chalcogenide element, or at least one material with gold, platinum, iridium, iron or other row 4, 5, or 6 metals. In some embodiments of the present disclosure, the doping component comprises: a chemical species with oxygen atoms, halide atoms, one or more of nitrate, a phosphate, a thiophosphate, a silicate, a thionyl chloride, a sulfur chloride, a silicon chloride, a thiophosphate, a thionyl nitrate, a silicon nitrate, a silicon nitrite, a sulfur oxide and a nitrous oxide gas. Without being bound by any particular theory, the desired chemical properties of the doped GNC product may include: a greater electrical conductivity (as compared to a non-doped GNC product), enhanced electrical charge storage (as compared to a non-doped GNC product), a heterogeneous catalytic property, a homogeneous catalytic property, a fuel cell catalytic property, an aerobic oxidation catalytic property, an enhanced reaction activity property and any combination thereof. The desired physical chemical properties of the doped GNC product made according to the embodiments of the present disclosure may have a wide variety of applications, such as: catalysts, heavy metal removal, energy storage, sorption applications, batteries, ultra-sensitive sensors and combinations thereof. For clarity, transition metals that are used as a nucleating agent during the initial root or tip growth phase of making the carbon nanostructures constituent within the GNC product are either not the type of chemical element that will impart the desired chemical properties to the constituent structures of the GNC product or they are not used in a sufficient amount so as to impart the desired chemical properties.

In some embodiments of the present disclosure, the GNC product made according to the methods, apparatus and systems described herein above, may result in a magnetic GNC product. For clarity, a magnetic GNC product is includes magnetic carbon nanostructures as constituent structures where some, most or substantially all of such constituent carbon nanostructures contain a sufficient amount of magnetic chemical elements so as to be physically movable with a magnetic field. For example, the movability in response to a magnetic field may be due to the increased presence of magnetic chemical elements positioned within individual carbon nanostructures that are constituent within the GNC product, where such presence extends substantially throughout each carbon nanostructure. This substantial extension throughout each carbon nanostructure is in contrast with the presence of nucleation agents, such as a transition metal, that facilitates the initial root or tip growth of a given carbon nanostructure within the GNC product. For clarity, transition metal nucleating agents may be useful in contributing towards making magnetic carbon nanostructures but such nucleating agents alone are insufficient in making magnetic carbon nanostructures as they do not impart a sufficient amount of magnetic chemical elements into the carbon nanostructures. Without being bound by any particular theory, if a magnetic additive component, is introduced into the method, apparatus or system, then growth of various carbon nanostructures within the magnetic GNC product occurs. In some embodiments of the present disclosure, the magnetic additive component comprises at least one of a magnetic material addition component, a carbide-growth component and any combination thereof. In some embodiments of the present disclosure, the magnetic material addition component is wherein the magnetic material additive component is one or more of iron, nickel, cobalt, gadolinium, samarium, neodymium, steel and alloys comprising one or more magnetic materials with ferromagnetic properties, paramagnetic properties, diamagnetic properties and any combination thereof. In some embodiments of the present disclosure, the iron-based additive is one or more of cast iron powder, iron metal, steel, stainless steel, an iron containing metal alloy, an iron oxide, FeO, Fe₂O₃, Fe₃O₄, or an iron containing salt. Within the magnetic GNC product, the magnetic additive component is incorporated or formed as one or more nodules, that may be covered in one or more layers of graphitic carbon, on the magnetic GNC product. In some embodiments of the present disclosure, the carbide-growth component may be a metal carbide, such as: iron carbide, a nickel carbide, a cobalt carbide; a zirconium carbide, a chromium carbide, a tantalum carbide, a hafnium carbide and any combination thereof. In some embodiments of the present disclosure, the carbide-growth component may be a non-metal carbide, such as silicon carbide, a germanium carbide and any combination thereof. The magnetic additive component may be added to the methods, apparatus and systems of the present disclosure, as a chemical additive or it may originate from one or more walls of the electrolysis cell, from the anode, from the cathode, the electrolyte media and any combination thereof.

### Examples

For Examples 1 to 9, the constituents of the molten electrolyte mixtures described herein are commercially available: strontium carbonate (SrCO₃); Chemsavers, about 98% pure or about 99% pure, strontium oxide (SrO); Chemsavers, about 98% pure or about 99% pure, barium carbonate (BaCO₃; Alfa Aesar, about 99.5% pure), lithium carbonate (Li₂CO₃; Alfa Aesar, about 99% pure), sodium carbonate (Na₂CO₃; Alfa Aesar, about 99% pure), lithium oxide (Li₂O; Alfa Aesar, about 99.5% pure), and barium oxide (BaO; Alfa Aesar, about 97% pure).

For the other examples, the constituents of the molten electrolyte mixtures employed in the examples below were commercially available: lithium carbonate was purchased as battery grade >99.5%, and used as received. The lithium carbonate had a compositional analysis of 99.8% (Li₂CO₃, Green Chemical Co). Strontium carbonate used was 99.4% purity SrCO₃ (Shendong Zhi Chemical Co. Strontium oxide, SrO (99% purity, Chemsavers) and used as an electrolyte constituent component. A lower purity SrCO₃ (98.6%; Hengshui Haoye Co,) containing minor ternary mix components (0.8% BaCO₃ and 0.2 wt % CaCO₃) was also compared to the higher grade SrCO₃ in the solubility sections described below. BaCO₃ (Alfa Aesar, 99.5%), Na₂CO₃ (Alfa Aesar, 99%), Li₂O (Alfa Aesar, 99.5%), and BaO (Alfa Aesar, 97%), were combined to form the various low-lithium carbonate electrolytes described in the examples below.

Muntz Brass (0.25 inch thick in the <2000 cm², and 0.5 inches thick in the larger cathode study) is a high zinc brass alloy composed of 60% copper and 40% zinc, also referred to as 280 brass, served as the cathode, and was purchased from onlinemetals.com, and in larger quantities from Marmetal Industries. As described herein, some examples relate to electrolysis processes that were conducted in 304 stainless steel “carbon pots”. The pot acts as both the cell case and its inner walls serve as the anode. In one case, as described hereinbelow, the pot inner wall was lined with Nichrome A to serve as an alternative electrolysis anode.

For various of the electrolysis processes described herein below, a variety of sized 304 stainless cases were used. In each case, the cathode was mounted vertically in the electrolyte and across from the carbon pot wall serving as the anode and immersed in the electrolyte. When larger cathodes were used, they were maintained in large thermostatically controlled kilns. These kilns simultaneously sustained electrolysis in several carbon pots. The electrolyte has a strong affinity for CO₂ from the open air, and air was used as the CO₂ source. The kilns can also be configured to effectively use as an alternative CO₂ source. For example, the kilns can receive a direct feed of a 5% CO₂ emission from a 860 MW natural gas electric power plant. The electrodes were immersed subsequent to melting of the electrolyte. Once melted, the electrolytes were maintained at about 750° C. to about 790° C. The electrolysis process was conducted galvanostatically with a described constant current density. CO₂ was transformed into carbon at the cathode, growing as a carbanogel containing a matrix of the GNCs and the molten electrolyte.

Specific electrolyte compositions were pre-mixed by weight in the noted ratios for each of the electrolytes described below. For the electrolysis potential measurements, the electrolyte to be studied was melted in at 770° C. in a small (12 cm×1×2 cm×15 cm tall) 304 stainless steel case. A 0.2 cm wide, 1.5 cm long Muntz brass cathode wire was placed 3 mm from a flat, oversized (3 cm×6 cm) 304 stainless steel anode and immersed in the electrolyte. Electrolysis potentials were measured. Fixed galvanostatic currents were applied and the electrolysis was measured via a DataQ DAQ interface.

Subsequent to the electrolysis process, the cathode raw product was cooled, collected from the cathode, ground and remelted and pressed and/or aqueous acid washed. The washed carbon product was separated by vacuum filtration. The washed carbon product was dried overnight at 60° C. in an oven, yielding a black power product.

The GNC product made by the examples below were washed (with either deionized water or up to 6 M HCl) to remove excess electrolyte, separated from the washing solution, and analyzed by PHENOM Pro-X Energy Dispersive Spectroscopy on the PHENOM Pro-X scanning electron microscope (SEM); by high resolution FEI Tenco LV SEM, and/or by FEI Talos F200X transmission electron microscope (TEM) with High Angle Annular Dark-Field analysis (HAADF).

Raman spectroscopy was measured with a LabRAM HR800 Raman microscope (HORIBA) with 532.14 wavelength incident laser light, with a high resolution of 0.6 cm⁻¹.

Thermogravimetric analysis (TGA) was measured with a Perkin Elmer STA 6000 TGA/DSC with autosampler instrumentation.

Example 1 relates to producing high-purity, graphene nanocarbons, such as carbon nanotubes, by electrolysis in pure (100 wt %) molten lithium carbonate.

In order to make GNC product, an electrolysis reaction was conducted in an electrolysis cell with an anode and a cathode.

The anode was configured to generate oxygen during the electrolysis reaction. The anode was made of stainless steel 304 and was substantially flat planar.

The cathode was made of brass and it was also substantially flat planar.

In this Example 1, the electrolyte was pure (100 wt %) lithium carbonate (Li₂CO₃). The electrolyte was heated to about 750° C. and positioned within the electrolytic cell between the anode and the cathode.

The electrolysis reaction was initiated by applying a substantially constant current density of about 0.2 A/cm².

Carbon dioxide from the air was directly captured by the molten electrolyte during the electrolysis reaction.

After about 4 hours, the electric current was turned off and the electrolysis reaction was stopped. The cathode was removed from the tubular vessel and allowed to cool and the solid GNC product was removed from the cathode.

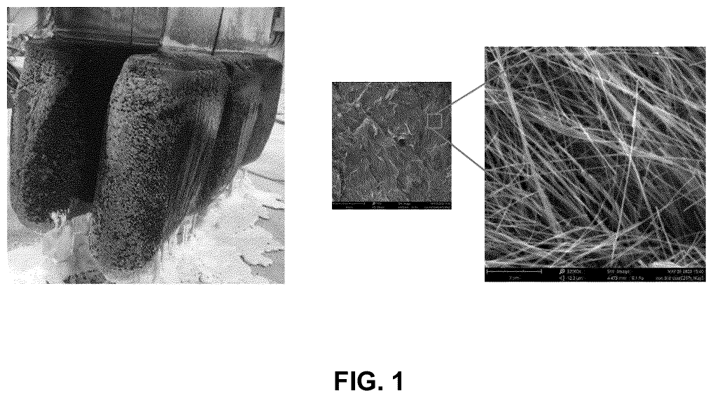

The left side of FIG. 1 is a photograph of an extracted cathode after electrolysis of CO₂ for 16 hours at 2620 Amp in a pure 750° C. Li₂CO₃ electrolyte. The photograph includes frozen electrolyte removed with the cathode. CO₂ has been split in a pure 750° C. Li₂CO₃ electrolyte. The white color of the frozen electrolyte is indicative of the high purity of the post electrolysis pure Li₂CO₃. During the electrolysis, the molten Li₂CO₃ electrolyte and cathodes are contained within a 304 Stainless Steel “carbon pot” which also serves as the oxygen generating anode. The product shown resides on the 13,104 cm² Muntz Brass cathodes. Post electrolysis the product is subsequently pressed/and or washed to remove and recover remaining electrolyte from the product. SEM of the washed product is shown in the middle and right sides of FIG. 1. The SEM on the middle and right respectively are at a magnification of ×710 and ×2250, and exhibit a CNT of purity 93%.

FIG. 2 presents a TGA analysis of the FIG. 1 electrolysis GNC product. FIG. 2 shows a purity of 97.1% of the Li₂CO₃ electrolyte used in the CO₂ electrolysis process that made the GNC product of FIG. 1. Furthermore, the TGA exhibits an inflection temperature of T_{infl}=610° C., which is indicative of a temperature resistant nanographene structure, and is unlike an alternative common amorphous carbon which oxidizes at a several hundred degrees lower temperature.

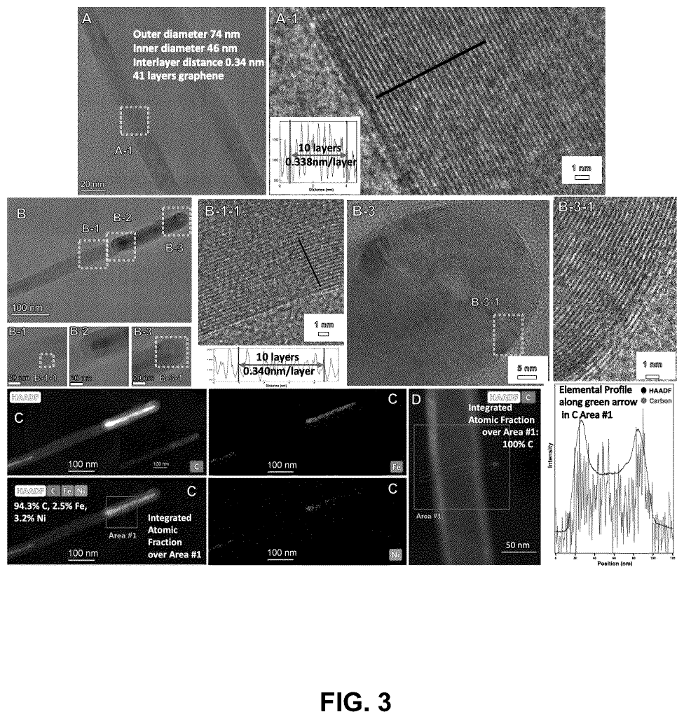

FIG. 3 presents TEM (Transmission Electron Microscopy, panels A & B) and Elemental HAADF (High Angle Annular Dark-Field analysis, panels C & D) of high-purity, high-yield carbon nanotubes synthesized by electrolytic splitting of CO₂ in 770° C. Li₂CO₃. In the top row a cross section of the CNT product is analyzed by TEM with scale bars of 20 nm (left panel) or 1 nm (right), and on the right the alignment and spacing of the single carbon atom thick cylindrical graphene walls is evident. In the middle the nanoscopic structure at the tip of the CNT includes graphene walls curving around a transition metal nucleation point, and in the lower row the iron composition of this nucleating metal is evident, as well as the pure carbon composition of the remainder of the carbon nanotube.

The average GNC purity ranges from 90 to 98% purity, depending on pure Li₂CO₃ electrolysis conditions and post electrolysis press extraction and/or polish washing. In accord with the electrolytic splitting of CO₂: CO₂->C_{GNC}+O₂; 1 tonne of GNC are synthesized via the C2CNT (carbon dioxide to carbon nanomaterial technology) process effectively removes 3.7 tonnes of carbon dioxide from the atmosphere or flue gas. CNTs have found applications in materials such as polymers, batteries, cement, textiles.

Example 2 relates to producing a variety of high purity graphene nanocarbon (GNC) structures by electrolysis in generally pure (100 wt %) molten lithium carbonate.

This example used many of the same steps as Example 1, with one exception being the modification of the electrochemical conditions resulting in the formation of a variety of high purity graphene nanocarbons in addition to carbon nanotubes.

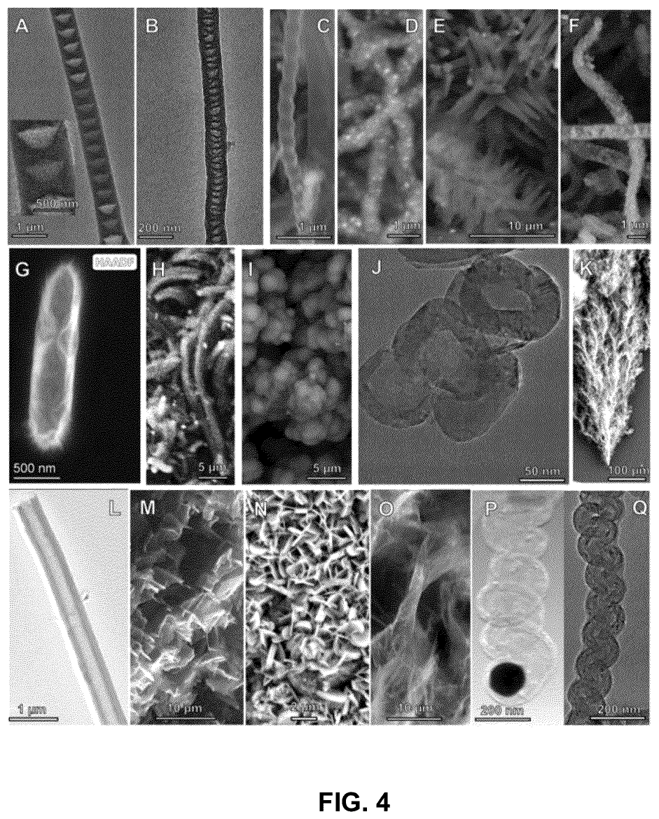

Representative examples of several of other GNC structures grown from CO₂ in Li₂CO₃, or Li₂CO₃ plus Na₂CO₃, electrolytes are shown in FIG. 4. These alternative GNCs are each prepared by varying the molten carbonate electrolysis conditions, such as variation of the temperature, current density and the composition and structure of the electrodes. Carbon nanotubes constrain graphene as concentric cylinders forming the CNT walls.

The alternative GNCs, constrain the conventional 2 dimensional planar graphene sp² planar morphology, within a variety of geometric shapes, such as carbon nano-onions (concentric graphene hollow or solid spheres), conventional graphene, nanoscaffold, nano-bamboo, nano-platelets, nano-pearls, nanorods, nano helices (including helical CNTs, braided double helical CNTs, and flat nanospirals), nano-rods, nano-dragons, nanobelts, conical nanofibers nanotrees, nanoweb, and nanosponges. These alternative morphologies further tune graphene's extraordinary strength, conductivity, lubrication, catalysis and electronic properties, within a variety of geometric shapes.

FIG. 4 presents SEM of nanocarbon allotropes synthesized by the electrolytic splitting of CO₂ in molten carbonate. Top row (from left to right): conical CNF, nano-bamboo, nano-pearl, Ni-coated CNT, nano-flower, nano-dragon. Middle row: nano-rod, nano-belt, nano-onion, hollow nano-onion, and nano-tree. Bottom row (from left to right) Carbon nanotube, nano-scaffold, nano-platelet, graphene, and nanocarbon helices.

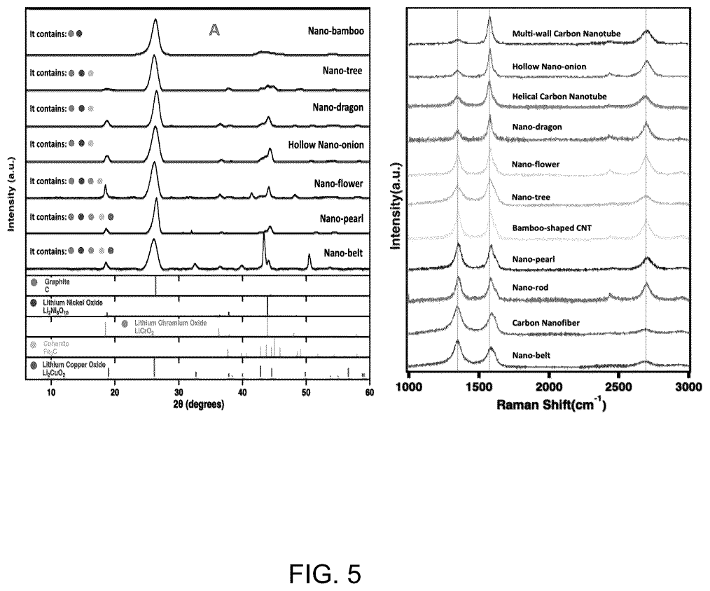

The left side of FIG. 5 presents XRD Spectra of several alternative GNC products synthesized by the electrolytic splitting of CO₂ in pure Li₂CO₃, or Li₂CO₃ with Na₂CO₃ through variation of the electrolysis conditions. In the XRD analysis, a strong crystalline graphene (non amorphous) peak is evident at 2θ=˜26° C., while the additional presence of nickel, iron, chromium and copper salts is distinctive to the various GNC structures.

The right of FIG. 5 presents Raman Spectra of several alternative GNC products synthesized by the electrolytic splitting of CO₂ in pure Li₂CO₃, or Li₂CO₃ with Na₂CO₃ through variation of the electrolysis conditions. In the Raman spectral, the ratio of the D (defect) peak intensity at ˜1300 cm⁻¹ to G (graphene) peak at ˜1600 cm⁻¹ is indicative of the number of defects to the graphene structure.

Example 3 relates to the high cost lithium carbonate and the challenge of its partial replacement by low cost sodium or potassium carbonate.

This example used many of the same steps as Example 1. The primary difference with Example 1 was the partial replacement of the lithium carbonate electrolyte with either sodium or potassium carbonate.

Li₂CO₃ is expensive and contributes to a cost constraint in its use as a molten electrolyte in the transformation, by electrolytic splitting of the greenhouse gas CO₂, to GNCs. Due to the competitive demand of Li₂CO₃, in particular for use in the preparation of Li-ion batteries for the growing electric vehicle (EV) market, global Li₂CO₃ prices in 2022 to 2023 have increased and vacillated in the range of $25,000 to $75,000 per tonne. These elevated prices present a cost constraint to the alternative use of Li₂CO₃ as a molten electrolyte in the transformation, by electrolytic splitting, of Li₂CO₃ to GNCs.

Alternatively, Na₂CO₃ and K₂CO₃ are available at a much lower global cost of less than $2,000 per tonne.

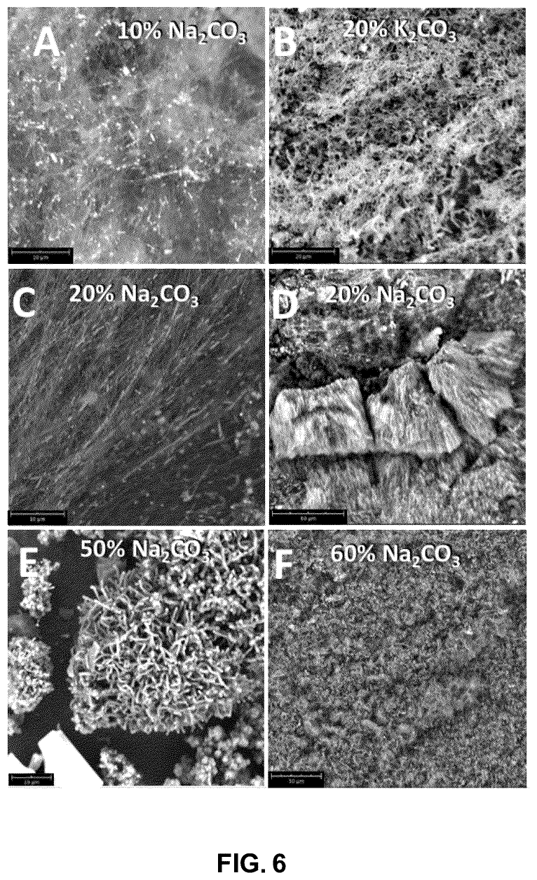

However, even low-level additions of these alternative sodium or potassium carbonates, to replace some of the Li₂CO₃, substantially disfigures the morphology of the GNCs. The morphology of the GNCs is improved by the addition of low levels of metaborates, such as 8 wt % LiBO₂. However, as shown in the SEM images of FIG. 6, even with the inclusion of LiBO₂, the addition of more than 10 wt % K₂CO₃, or more than 20 wt % Na₂CO₃, to Li₂CO₃ as a molten electrolyte for CO₂ electrolysis results in the loss of CNT structure, both in the drop in CNT purity, and a drop in the CNT aspect ratio (the ratio of the CNT length to its diameter) in the electrolysis product.

Example 4 relates to a high melting-point of strontium carbonate and the unexpected high solubility of strontium salts in low temperature molten Li₂CO₃.

Unlike the global Li₂CO₃ prices of $25,000 to $75,000 per tonne, SrCO₃ is available or a more stable global price of approximately $1,500 per tonne; a cost that is 1 to 2 orders of magnitude less than Li₂CO₃. However, its 1494° C. melting point is too high for CO₂ electrolysis to solid carbon products. This melting point is considerably higher than the respective 723° C., 851° C. or 891° C. melting points of Li₂CO₃, Na₂CO₃ or K₂CO₃.

Electrolysis in molten carbonates containing over 10 wt % SrCO₃ had been an unexplored domain. While binary mixes of Li₂CO₃, Na₂CO₃ and K₂CO₃ have been well characterized, there is little information available on the melting point of the binary Li₂CO₃/SrCO₃ mixture. However, it is discovered that a mix of over 45 wt % SrCO₃ and 55 wt % Li₂CO₃ melts at less than 750° C., increasing to 50 wt % or more at 780° C. In addition, strontium oxide, SrO, which is useful in the rapid reactive dissolution of CO₂, is measured here to be highly soluble (at ˜25 wt % in Li₂CO₃ at 750° C.). Efficacy of these salts as molten electrolytes at temperatures below 800° C. is of import as above these temperatures CO₂ increasingly electrolytically splits to gaseous CO, rather than the desired solid phase GNC products, and by 950° C. the product is entirely CO, rather than solid GNC structures.

Example 5 relates to a different affinity of strontium, compared to sodium or potassium, carbonate to bind and release carbon dioxide.

An affinity for carbon dioxide is a critical component in the molten carbonate electrolytic transformation of CO₂ to GNC structures. The equilibrium for alkali and alkali earth carbonates to separate to carbon dioxide and oxides, or to form carbonate from them in the reverse reaction, is given by a generalization of EQN. 5:

MCO₃ [symbol] CO₂+MO KMCO₃=p_{CO2}a_{MO}/a_{MCO3} (EQN. 6)

where examples of M are Liz, Na₂, K₂, Mg, Ba or Sr.

When calculating the equilibrium, K_{MCO3} EQN. 6 is used:

ΔG°M_{CO3}=−RT ln K_{MCO3} (EQN. 7)

K_{MCO3} is calculated from the thermochemical free energies for a variety of alkali and alkali earth carbonates, their oxides, and from CO₂.

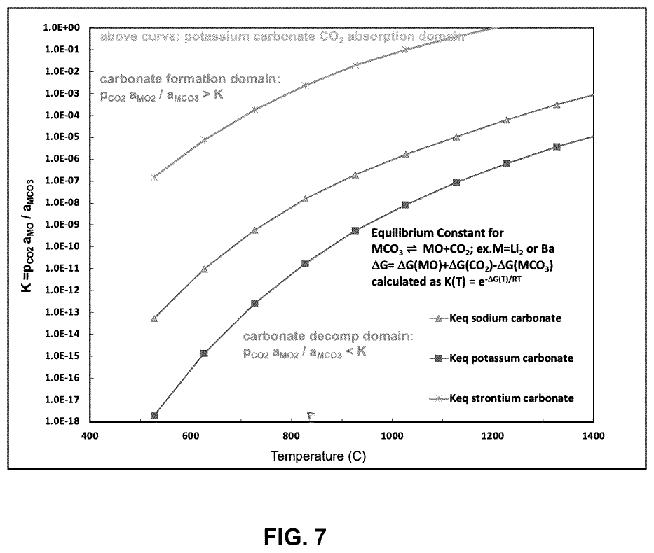

FIG. 7 presents a comparison of carbonate equilibrium constants to bind and release carbon dioxide by strontium carbonate compared to that of sodium or potassium carbonate. These are plotted as a function of temperature. Interestingly, it is seen in FIG. 7 that strontium carbonate more loosely binds carbon dioxide than these other higher melting point carbonates with a higher melting point than lithium carbonate. This is particularly important in the low temperature domain in which strontium carbonate can also be soluble in molten lithium carbonate. Without being bound by any particular theory, this molten domain and loose binding of CO₂, provides an unusual media conducive for the electrolytic splitting of carbon dioxide and its transformation to GNCs.

Example 6 relates to electrolysis production of high purity CNTs in a binary SrCO₃/Li₂CO₃ molten electrolyte.

This example used many of the same steps as Example 1. The primary difference with Example 1 was the partial replacement of the lithium carbonate electrolyte with strontium carbonate or strontium oxide.

As opposed to the Na₂CO₃ or K₂CO₃ mixes in Li₂CO₃ in Example 3, we discover that the binary SrCO₃/Li₂CO₃ electrolyte mix has the capability to form highly perfect GNC structures. FIG. 7 presents SEM of the carbon nanotube product of a 25 wt % SrCO₃/75 wt % Li₂CO₃ electrolysis of CO₂ at 750° C. with a Muntz brass cathode and a stainless steel 304 anode.

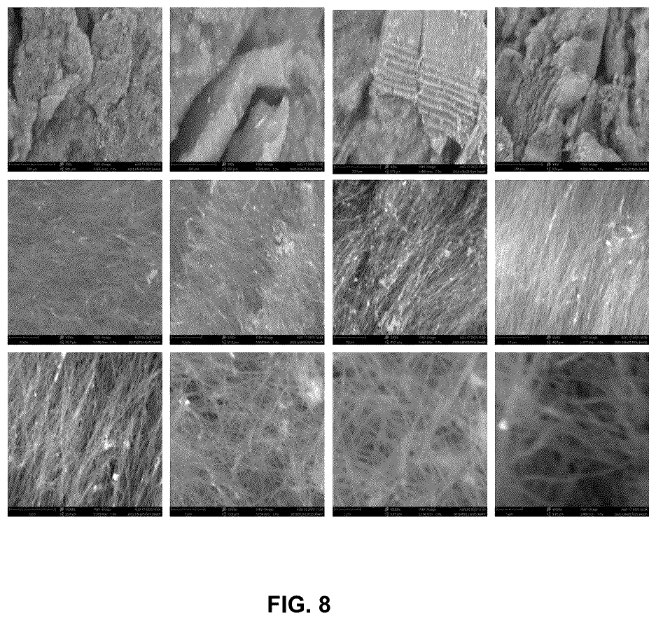

In comparison to FIG. 1, the carbon nanotube product in FIG. 8 is superior to that of the CNTs grown in the pure Li₂CO₃ electrolyte. In particular, the purity is high and the desirable property of the CNT aspect ratio of the Sr/Li carbonate CNTs increases compared the pure Li₂CO₃ electrolyte, as both the diameter decreases (to 60 to 80 nm), while the CNT length increases (to 200 to 500 μm in length).

Example 7 relates to 750° C. strontium binary salt (SrO or SrCO₃)/Li₂CO₃ production of high purity CNTs in a wide range of electrochemical conditions.

This example used many of the same steps as Example 6. The primary differences with Example 5 were a change in the strontium salt to strontium oxide from strontium carbonate, or change in the wt % of strontium carbonate, or change in the electrolysis current density, electrolysis duration of the number of times the electrolyte and electrodes were reused to form the carbon nanotube product.

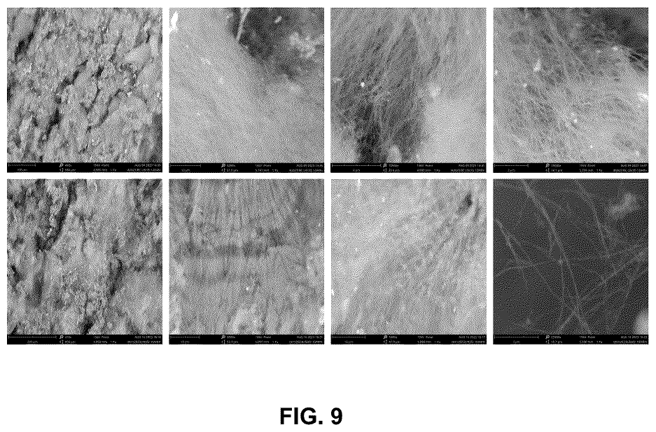

Table 1 compares for several lower lithium content electrolyte, under various electrochemical conditions the carbon nanotube product to that of the comparable product in a pure grown in a pure Li₂CO₃ electrolyte. Each synthesis is conducted with a Muntz brass cathode and a stainless steel 304 anode at 750° C. Table 1 summarizes that the quality of the binary electrolyte CNT product is comparable to that formed by electrolysis in pure Li₂CO₃, if either SrO or SrCO₃ is used as the binary strontium salt. The term “superior quality” refers to CNTs with an average length over about 70 μm and an average aspect ratio of over about 1,000. Superior quality also refers to CNTs with an average purity of over about 98%. The term “comparable quality” is in reference to those CNTs made in an electrolysis process with a pure Li₂CO₃ electrolyte and refers to CNTs with an aspect ratio of about 100 to about 1,000, and/or a lower fraction of the CNTs with an aspect ratio of about 10 to about 100. Comparable quality also refers to CNTs with an average purity of about 90 to about 95% and/or a lower fraction of the CNTS with an average purity of about 90% to about 95%. The high quality of the strontium binary electrolyte product appears to be independent of the electrolysis current density or the duration of the electrolysis over a wide range, and furthermore it is evident that the electrolyte and electrodes can be reused for multiple syntheses. The top row of FIG. 9 presents SEM of the carbon nanotube product of a 35 wt % SrCO₃/75 wt % Li₂CO₃ electrolysis of CO₂ at 750° C. with a brass cathode and a stainless steel 304 anode.

TABLE 1
Comparison of the CNT product quality for several lower
lithium content electrolytes by electrolysis at 750° C.

| | | | Electrolysis | | Times | Quality of CNT |
|---|---|---|---|---|---|---|
| | | | current | | reuse of | compared to |
| Strontium | Wt % | Wt % | density, | Electrolysis | electrolyte | pure Li₂CO₃ |
| salt | Sr salt | Li₂CO₃ | A/cm² | time, hours | electrodes | product |
| SrO | 10% | 90% | 0.2 | 4 | 1 | comparable |
| SrCO₃ | 10% | 90% | 0.2 | 4 | 1 | comparable |
| SrCO₃ | 25% | 75% | 0.1 | 16 | 2 | comparable |
| SrCO₃ | 25% | 75% | 0.2 | 4 | 3 | superior |
| SrCO₃ | 25% | 75% | 0.2 | 4 | 9 | comparable |
| SrCO₃ | 35% | 65% | 0.1 | 16 | 4 | comparable |
| SrCO₃ | 35% | 65% | 0.4 | 4 | 5 | comparable |
| SrCO₃ | 45% | 55% | 0.2 | 4 | 2 | comparable |

Example 8 relates to 750° C. SrCO₃/Li₂CO₃/Na₂CO₃ ternary production of high purity CNTs.

This example used many of the same steps as Example 6. The primary differences with Example 6 was a lower concentration of lithium carbonate in the lower-lithium carbonate electrolyte. This was accomplished by changing the electrolyte from a binary mix of SrCO₃ and Li₂CO₃ to a ternary mix of 33.3 wt % SrCO₃/33.3 wt % Li₂CO₃/33.3 wt % Na₂CO₃. Separate electrolysis processes were conducted both at either 0.1 A/cm² (for 16 hours) or 0.2 A/cm² (for 4 hours). The electrolyte was reused for several electrolysis processes. The bottom row of FIG. 9 presents SEM of the carbon nanotube product of this ternary electrolyte prepared with a third use of the electrolyte over a 4 hour electrolysis at a current density of 0.2 A/cm² with a brass cathode and a stainless steel 304 anode at 750° C. The quality of the CNT product is comparable to the product prepared by electrolysis in the simple Li₂CO₃ electrolyte.

Example 9 relates to 780° C. lower lithium SrCO₃/Li₂CO₃ binary production of high purity CNTs.

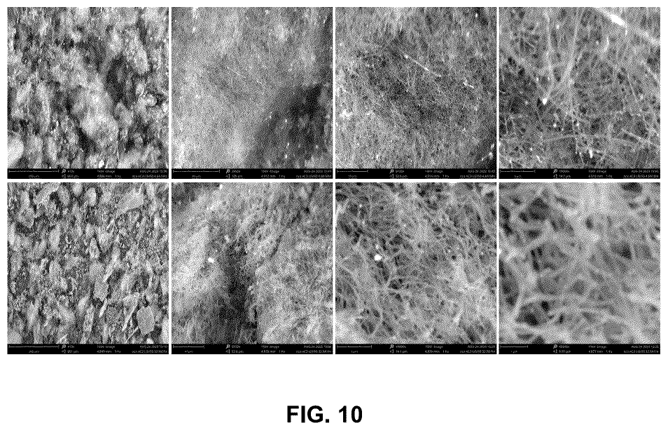

This example used many of the same steps as Example 7. The primary difference with Example 7 was the electrolysis was conducted at a higher temperature (780° C. rather than 750° C.) to facilitate a higher solubility of strontium carbonate (increasing the fraction of SrCO₃ to 50 wt %) to investigate a lower fraction (50 wt %) of lithium carbonate in the binary electrolysis electrolyte. This was accomplished at 780° C. conducting separate electrolysis processes, while reusing a stainless steel 304 anode and a brass cathode. Similarly in the different electrolysis processes, the, electrolyte was reused for electrolysis processes at a wide range of different current densities: from 0.07 or 0.1 A/cm² for 16 hours, 0.2 A/cm² for 4 hours, and 0.4 or 0.5 A/cm² for 1 hour. FIG. 10 presents SEM images of the washed carbon nanotube product of electrolysis at a low current density (0.07 A/cm² for 16 hours) and a high current density (0.5 A/cm² for 1 hour).

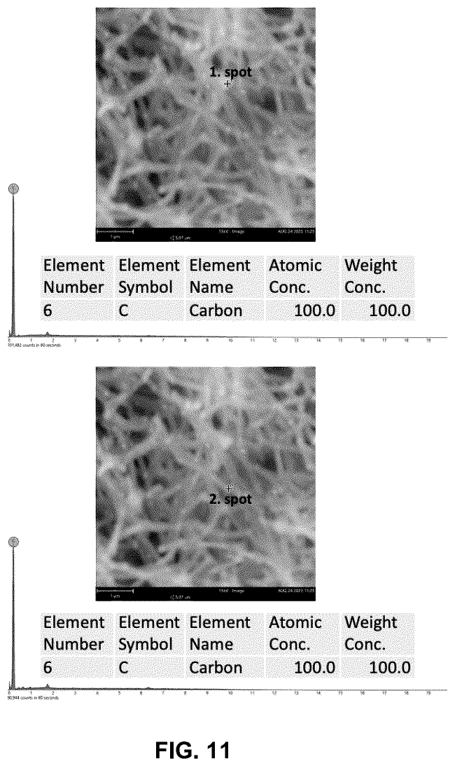

FIG. 11 presents SEM elemental analysis by EDS (Electron Dispersive Spectroscopy) at two different locations noted by hatch marks in FIG. 11 of the 0.5 A/cm² carbon nanotube product shown in the bottom row of FIG. 10. As seen in FIG. 11, the CNT consists of 100% carbon. As seen in FIG. 10 and FIG. 11, the quality of the CNT product is comparable to the product prepared by electrolysis in the simple Li₂CO₃ electrolyte.

It is also observed that with addition to the binary SrCO₃/Li₂CO₃ electrolyte, that 0 to 15 wt % of a barium salt, such as BaO₃ or BaO, or the addition of a boron salt, such as Na₂B₄O or B₂O₃, that a variety of GNC structures can be synthesized by electrolysis upon their addition to a binary SrCO₃/Li₂CO₃ electrolyte,

As with lithium or barium oxide, and unlike calcium oxide, strontium oxide is also highly soluble in carbonate electrolytes. The GNC product is also evident with the addition of 1% or 5% of either borate or oxide salts to the electrolytes of Examples 5 and 6. The inclusion of the lithium borate in the electrolyte can form boron doped carbon nanotubes.

The remaining examples describe further electrolysis processes that utilize a molten carbonate electrolyte with the constituent components as described therein further. The electrolysis processes employed the same operational parameters as described for the example above, except as set out below.

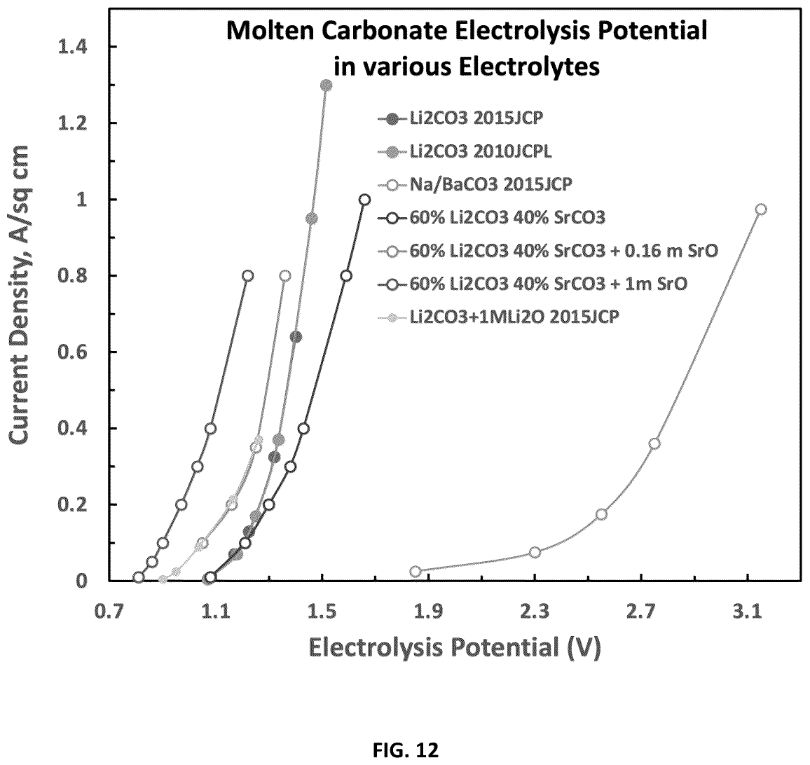

Example 10 relates to the carbonate electrolysis potential measured in several molten carbonates. The inventors have previously synthesized CNTs by electrolysis in 50/50 wt % Na/BaCO₃ albeit forming CNTs at a lower purity than from the pure Li₂CO₃. However, that synthesis required several fold higher electrolysis power to drive the reaction. FIG. 12 depicts a comparison of the molten carbonate electrolysis potential of several electrolytes. Compared to the 1 volt which drives the CNT formation in lithium carbonate, the Na/BaCO₃ potential results in a two to three-fold higher voltage and inordinately high energy consumption to drive a decarbonization process.

Potentials included in pure lithium carbonate, or pure lithium carbonate with 1.0 m Li₂O, an equal mix of sodium and barium carbonate, a mix of 40 wt % strontium carbonate with 60 wt % Li₂CO₃, or a mix of the latter with either 0.16 or 1.0 m SrO. Li₂CO₃ with or without Li₂O is from the measurements described in: Ren, J., Lau, J., Lefler, M., Licht, S. The minimum electrolytic energy needed to convert carbon dioxide to carbon by electrolysis in carbonate melts. J. Phys. Chem. C. 119, 23342-23349 (2015) and Licht, S.; Wang, B.; Ghosh, S.; Ayub, H.; Jiang, D.; Ganley, J. New solar carbon capture process: STEP carbon capture. J. Phys. Chem. Lett. 1, 2363-2368 (2010), the entire contents of which are both incorporated herein by reference. The Na/BaCO₃ are also described in Licht, S.; Wang, B.; Ghosh, S.; Ayub, H.; Jiang, D.; Ganley, J. New solar carbon capture process: STEP carbon capture. J. Phys. Chem. Lett. 1, 2363-2368 (2010).

Example 11 relates to solubility of strontium salts in molten lithium carbonate salts.

There is little, or no, information available regarding the melting point of a binary mix of pure Li₂CO₃ (melting point of about 723° C.) with SrCO₃ (which is solid to about 1494° C.). Although SrCO₃ fully decomposes to SrO, as temperature is increased <<1000° C. It was discovered, as described herein, that SrCO₃ is highly soluble in molten lithium carbonate at temperatures less than 800° C., and that the inexpensive SrCO₃ salt can replace a major portion of the expensive lithium carbonate salt as an electrolyte for decarbonization and CNT and GNC growth. It is described herein that strontium oxide, SrO, which can facilitate the rapid reactive dissolution of CO₂, is also measured here using 99% SrO to be highly soluble (at ˜25 wt % in Li₂CO₃ at 750° C.). The efficacy of these salts as electrolytes for molten electrolysis at temperatures below 800° C. is of import as above these temperatures CO₂ increasingly electrolytically splits to gaseous carbon monoxide, rather than the desired solid phase GNC products, and by 950° C. the product is entirely CO, rather than solid GNC.

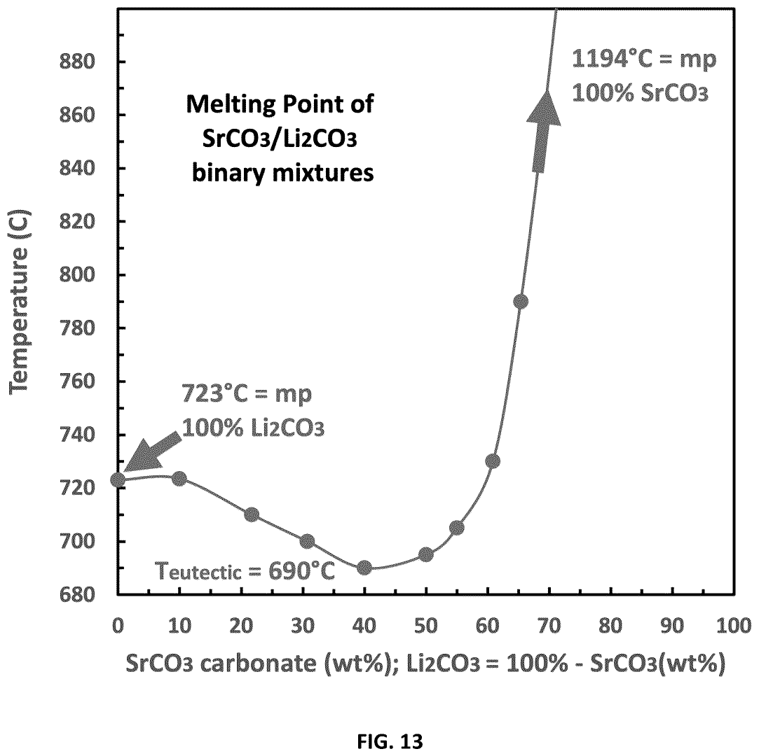

The measured melting point of binary mixtures of SrCO₃ and Li₂CO₃ binary as a function of temperature is presented in FIG. 13. From FIG. 13, it is seen that the solubility of 99.4% SrCO₃ in Li₂CO₃ (99.8%, Green Chemical Co) is up to 65 wt % in the regular CO₂ splitting temperature domain (T<800° C.). The binary mix exhibits a minimum (eutectic point) melting point at 690° C. occurring at a composition of 40 wt % SrCO₃. It is likely that ternary composed of Li—SrCO₃ plus other salt mixes will exhibit lower eutectic temperatures. A lower 98.6% purity SrCO3, containing minor ternary mix components (0.8% BaCO3 and 0.2 wt % CaCO3), exhibited a slightly lower eutectic temperature of 880° C. at 40 wt % composition in the same 60 wt % Li₂CO₃.

Example 12 relates to the overlapping affinity of strontium carbonate and lithium carbonate to bind and release CO₂.

An affinity for CO₂ is a critical decarbonization component in the molten carbonate electrolytic splitting and transformation of CO₂ to GNCs. In particular, the affinity of lithium carbon for CO₂ provides a balance that both facilitates rapid CO₂ intake into the molten salt, while providing an enriched carbon electrolytic media, that both facilitates electrochemical reduction of tetravalent carbon to carbon and as observed by the low overpotential to generate high electrolysis rates, but also to specifically generate GNCs, as observed by the high-purity of GNCs, such as CNTs. Below the CO₂ affinity of SrCO₃'s is calculated and it is revealed that unlike non-lithium alkali carbonates or other alkali earth carbonates, SrCO₃ exhibits a CO₂ affinity equivalent to that of Li₂CO₃. The equilibrium, K_{MCO3}, for alkali and alkali earth carbonates to separate to CO₂ and oxide, or to form carbonate from them in the reverse reaction, is given by the equilibrium for the decomposition, or in reverse for formation, of a carbonate from CO₂ and its oxide as shown in EQN. 6 above.

The equilibrium, K_{MCO3} is calculated from the relationship of equilibria and free energy, where the gas constant, R=8.31 J/mol K:

ΔG°M_{CO3}=−RT ln KM_{CO3};KM_{CO3}(T)=e^{-ΔG(T)/RT} (EQN. 8)

KM_{CO3} is calculated from the thermochemical free energies for a variety of alkali and alkali earth carbonates, their oxides, and CO₂.

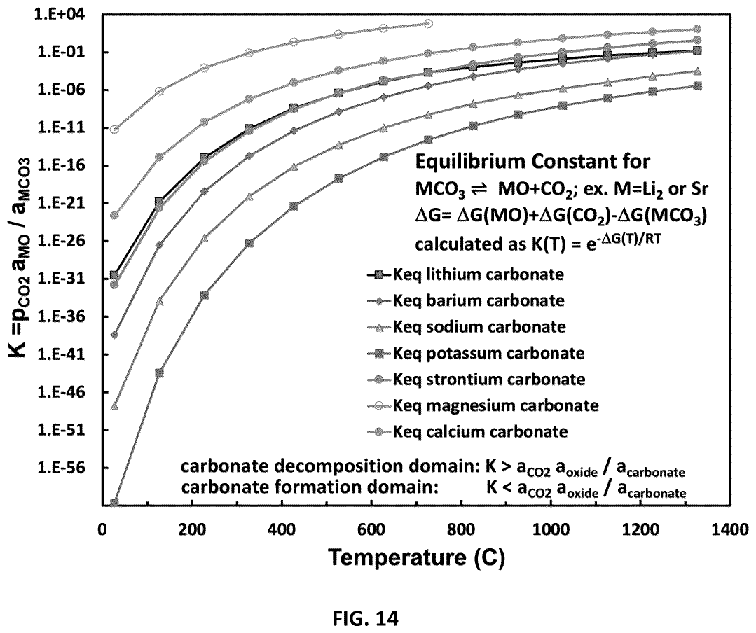

FIG. 14 depicts a comparison of carbonate equilibrium constants to bind and release carbon dioxide by strontium carbonate compared to that of alkali or other alkali earth carbonates. These are plotted as a function of temperature. The equilibrium constants as a function of temperature for strontium, lithium, sodium, potassium, and barium carbonate. Equilibria constants are calculated from the free energy in accord with EQN. 8. The free energy is calculated from the metal carbonate, metal oxide, and, carbon dioxide enthalpies and entropies Above any given salt's equilibrium curve; that is in the low CO₂ activity domain (a_{CO2} a_{oxide}/a_{carbonate}<K), the salt will spontaneously decompose, while in the high CO₂ activity domain, the salt will spontaneously form from CO₂ and the salt's oxide. Interestingly, FIG. 14 shows that the strontium carbonate equilibrium is similar to that of lithium carbonate and very different to that of the other carbonate salts. Specifically, the carbonate equilibria constants for strontium and lithium carbonate are nearly identical in the 400° C. to 800° C. domain in which lithium carbonate binary and trinary salt mixes are molten. We have previously observed a high tendency for electrolytic graphene nanocarbon formation in the 600° C. to 800° C. temperature range. At lower temperatures, the transition metal nucleation growth of carbon nanotubes is not observed, and at increasing temperatures above the 800° C., the 2-electron reduction to CO, rather than the 4-electron reduction to carbon increasingly dominates. It was postulated that the temperature domain from 600° C. to 800° C. for CO₂ splitting to GNCs is related to a “goldy locks” domain of affinity to bind and release CO₂ from molten carbonate. The comparable nature of the strontium to the lithium carbonate equilibria provides an unusual environment media conducive to the electrolytic splitting of carbon dioxide and its transformation to graphene nanocarbons.

Example 13 relates to overlapping electrolysis potentials of strontium carbonates and lithium carbonates.

FIG. 12 compared electrolysis potentials measured in 40 wt % strontium carbonate/60 wt % lithium carbonate electrolytes, both with and without added oxide, and compared these potentials to the electrolysis potentials for pure Li₂CO₃ with and without oxide, and also to the Na/BaCO₃ electrolyte. The electrolysis potential in a pure Li₂CO₃, as presented by the solid orange and dark blue dots, decreases when 1 m Li₂O is added to the electrolyte as presented by the solid yellow dots. The observed onset potential for CO₂ reduction decreased from 1.08V in the pure Li₂CO₃ electrolyte to 0.9 V with the 1 m Li₂O. As shown in FIG. 12, the onset potential is the same in pure Li₂O₃ as in the 40%/60% SrCO₃/Li₂CO₃ electrolyte. This correlates with the previously discussed similarity in the equilibria constants for the two salts shown in FIG. 13. The 40%/60% SrCO₃/Li₂CO₃ 770° C. electrolysis potential is presented as hollow dark blue circles. It is seen that this electrolyte exhibits a moderately higher overpotential at increasing current densities than the pure Li₂CO₃. Interestingly, the mixed 40%/60% electrolyte was more sensitive to oxide addition, as added SrO, than the pure Li₂CO₃ electrolyte, as added Li₂O. The addition of only 0.16 m SrO to the mixed electrolyte results in a similar decrease in potential to that in the 1 m Li₂O Li₂CO₃ electrolyte. As seen by the brown circles in FIG. 12, the addition of 1 m SrO to the 40%/60% SrCO₃/Li₂CO₃ electrolyte further decreased the electrolysis potential to an onset potential of only 0.8 V, and even at higher current densities, the electrolysis potential was lower than that in the Li₂CO₃ electrolytes.

Example 14 relates to strontium carbonate electrolyte electrolysis processes.

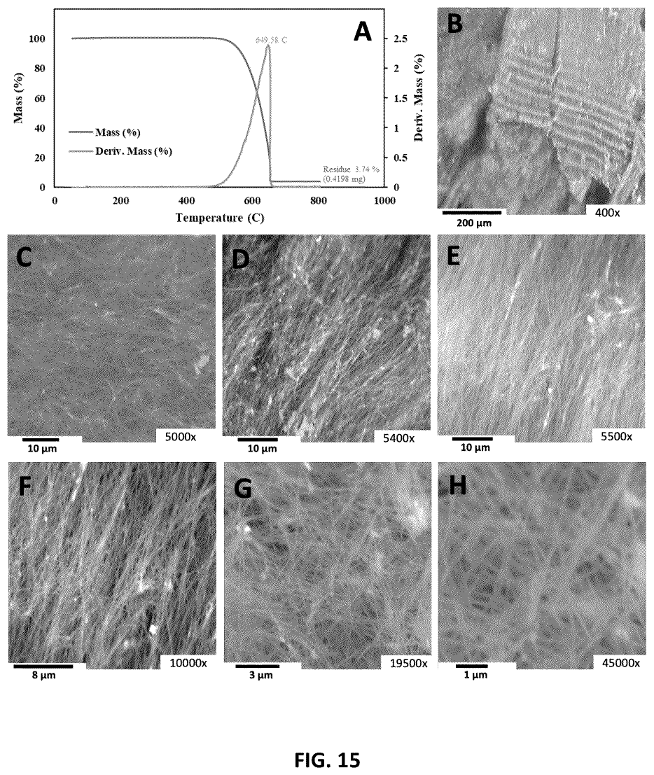

Electrolysis processes were performed for 4 hours at 750° C. in lithium carbonate electrolytes with an increasing concentration of strontium carbonate using a vertical, flat Muntz brass cathode sandwiched by vertical, flat stainless steel cathodes (anodes are provided by the walls of the carbon pot). The electrolysis was studied as a function of electrolyte composition, electrolysis current density, electrolysis, electrolysis time, the number of repeat uses of the electrolyte and carbon pot, and the electrolysis electrode size. For electrolytes containing either 10, 25, 35, or 45% strontium carbonate at 750° C., the resultant high-purity CNT product was comparable to that obtained with a pure lithium carbonate electrolyte. FIG. 15 presents the TGA and SEM of the product obtained from a 25 wt % SrCO₃ in Li₂CO₃ electrolysis conducted at a current density of J=0.2 A/cm² for 4 hours. In FIG. 15 the magnification of each panel was: B: 400×, C: 5000×, D: 5400×, E: 5500×, F: 10,000×, G: 19,500×, H: 45,000×.

As seen in FIG. 15, the CNTs are of comparable, high (>>90%) purity compared to the pure Li₂CO₃ product of FIG. 12 and from the TGA, the post-combustion residue is less than 4% while the TGA inflection point temperature for combustion is 650° C. EDS along the CNT strands in the SEM exhibit 100% elemental carbon, while SEM bright spots at the CNT tips are iron. In prior studies, the Raman spectra has been documented, TEM, points of nucleation, EDS and HAADF elemental analysis, and X-ray diffraction of the synthesized GNCs. Herein the focus was on the physical chemistry of the solubility, equilibration, and demonstration of the synthesis of high-purity GNCs, such as CNTs and carbon nano-onions, with an unusual series of readily available strontium carbonate electrolytes to ensure its wide-spread available for large scale decarbonization

A comparable CNT product was obtained at 0.2 A/cm² electrolysis current density for both less concentrated (10 wt %) and more concentrated (35 wt %) SrCO₃ in Li₂CO₃ electrolytes, each studied at a current density of J=0.2 A/cm². Additional electrolysis processes in the 25 wt % SrCO₃ electrolytes were repeated a total of 9 times reusing the same electrolyte and the same carbon pot and cathode. The electrolysis yielded comparable quality CNT product with no indication of any deterioration of the carbon pot, the anode comprising the inner walls of the carbon pot or the cathode.

Rather than a 4-hour electrolysis at 0.2 A/cm² current density, electrolysis processes were additionally conducted in the 25 wt % SrCO₃ electrolyte at a lower current density (0.1 A/cm²) and for a longer electrolysis duration (16 hours) product. Finally, a high current density 0.4 A/cm² electrolysis for four hours was performed in the 35 wt % SrCO₃ electrolyte. In both cases, the 0.1 A and 0.4 A electrolysis processes again produced a comparable quality carbon nanotube containing product.

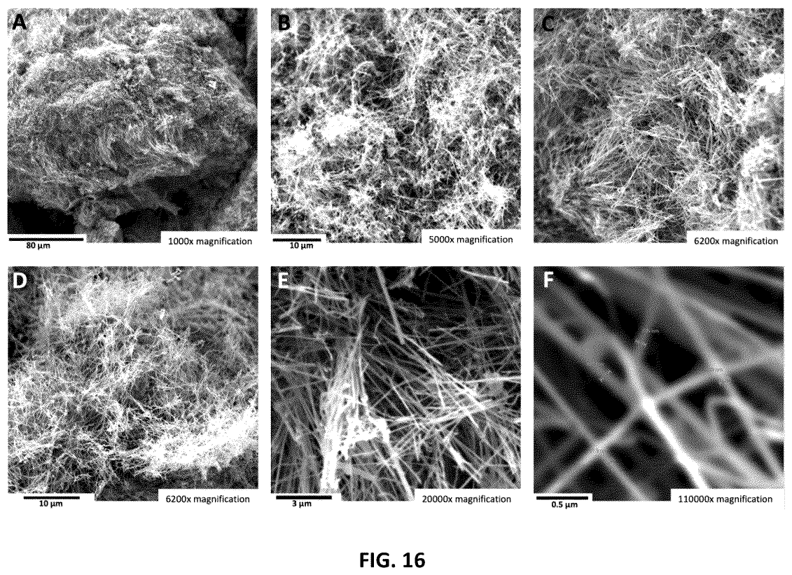

FIG. 16 shows SEM images of a carbon nanotube containing product from a high current 0.6 A/cm², four hour electrolysis in a 45 wt % SrCO₃ in Li₂CO₃ electrolyte at of 790° C. with a stainless steel 304 anode and a 120 cm² area brass cathode. The magnification of the panels in FIG. 16 are as follows: A: 1,000×, B: 5,000×, C: 6,200×, D: 6,200×, E: 20,000×, or F: 110,000×.

As shown in FIG. 16, the CNT containing product of the high current density electrolysis in the 45 wt % SrCO₃ electrolyte yielded comparable quality CNT product to those in FIG. 12 and FIG. 15. The inventors have previously demonstrated that high current density conditions can induce torsional growth of the CNTs, and a minor, but evident, increased tangling of the carbon nanotubes is seen in the high current density growth product in FIG. 16.

Example 15 relates to strontium carbonate electrolyte electrolysis processes with a greater amount of strontium carbonate.

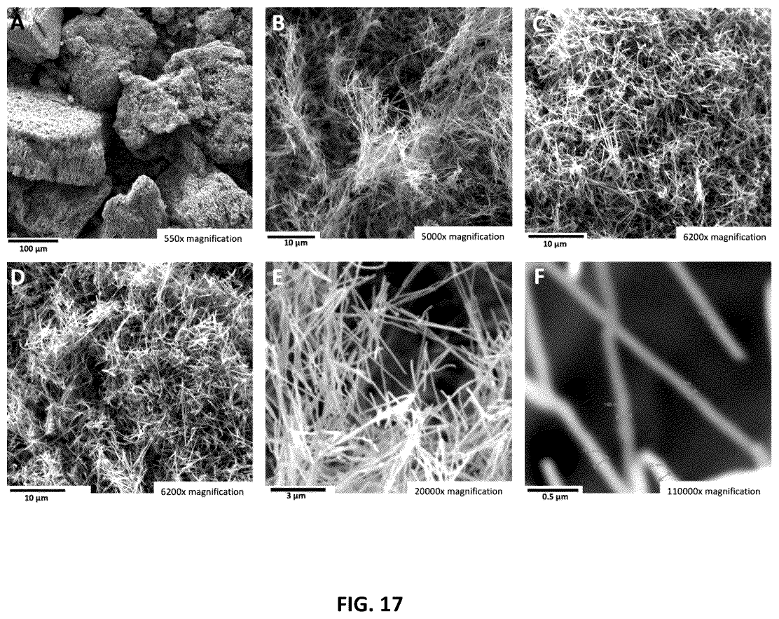

FIG. 17 shows SEM images of a CNT containing product of an electrolysis process performed for 16 hours with 50 wt % of each of strontium carbonate and lithium carbonate at 785° C. and a current density of 0.28 A/cm² with a stainless steel 304 anode at a 1,600 cm² area brass cathode. The magnification of the panels in FIG. 17 are as follows: A: 550×, B: 5,000×, C: 6,200×, D: 6,200×, E: 20,000×, and F: 110,000.

The higher amount of strontium carbonate (50 wt %) electrolysis processes were conducted at higher temperatures and a current density lower than 0.6 A/cm² to overcome anticipated mass transfer limitations. As shown in FIG. 17, the product of a 785° C. electrolysis at a current density of 0.28 A/cm² is high-purity CNT containing product.

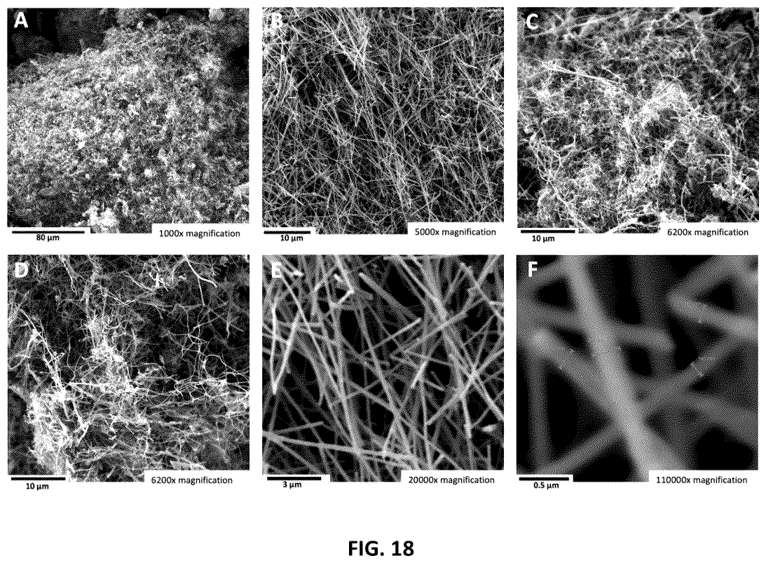

The success of the 50% SrCO₃ electrolysis process suggested that lower temperatures were viable for these strontium carbonate concentrated electrolytes. Therefore, a 60% SrCO₃ in 40% Li₂CO₃ electrolyte process was conducted for 16 hours at 770° using a current density of 0.2 A/cm² with a stainless steel 304 anode at a 288 cm² area brass cathode. FIG. 18 depicts the SEM images of this product of the 60% SrCO₃ and 40 wt % Li₂CO₃ electrolysis. The magnification of the panels in FIG. 18 are as follows: A: 1000×, B: 5,000×, C: 6200×, D: 6,200×, E: 20,000×, or F: 110,000×. Once again, a high-purity CNT product is attained.

Example 16 relates to electrolysis processes that use low-lithium carbonate electrolyte mixtures with more than two constituent components.

It has been demonstrated previously that low-level Li₂O additions can improve purities of the products of electrolysis processes that use a Li₂CO₃ electrolyte. The oxide can induce the formation of some twisting of the carbon nanotubes due to an increase of sp³ defects and in one case branched, rather than discrete CNTs can form. As with Li₂CO₃, Li₂O is an expensive lithium salt due to scarcity. As with SrCO₃, SrO is an inexpensive, and it can be inexpensive addition to a molten carbonate electrolyte for decarbonization.

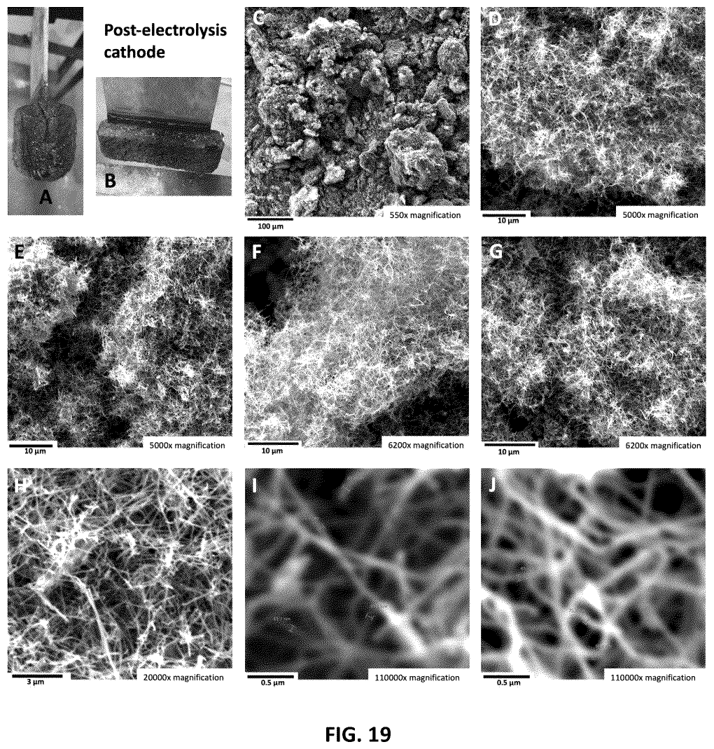

It was hypothesized that in the domain of using an electrolyte with a high strontium concentration, the addition of strontium oxide as a ternary compound to the binary SrCO₃/Li₂CO₃ electrolyte mixture may improve mass transfer (from carbon dioxide to the solid GNC product) by increasing strontium solubility and decreasing the viscosity. As shown in FIG. 19, a high-purity CNT product is indeed formed in a low Li₂CO₃ concentration, and high SrCO₃ concentration electrolyte upon the addition of SrO as a ternary component. The electrolysis was conducted for four hours at 770° C. at a current density of 0.6 A/cm² with a stainless steel 304 anode at a 96 cm² area brass cathode. The magnification of the panels in FIG. 19 are: C: 550×, D&E: 5,000×, F&G: 6,200×, H: 20,000×, and I&J: 110,000× magnification. The 64 wt % SrCO₃ plus 1% SrO electrolyte contained only 35 wt % Li₂CO₃. The product continued to comprise high-purity CNTs. As expected with the addition of an oxide, the CNTs are more twisted, but remain of high-purity. Interestingly, as seen in panels I and J of FIG. 19, the diameter of the carbon nanotube ranges from 70 to 90 nm, which is smaller than over 100 nm generally observed in the electrolytes without added oxide.

Example 17 relates to use of a strontium containing low-lithium carbonate electrolyte to produce a CNO product.

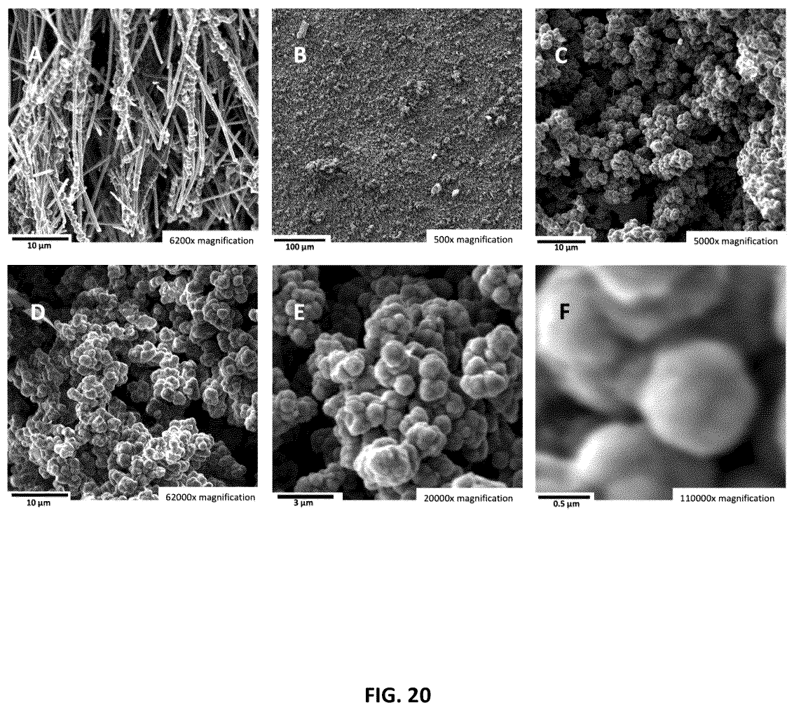

FIG. 20 shows the SEM images of CNOs synthesized using 54 wt % SrCO₃, 41 wt % Li₂CO₃, and 5 wt % Na₂CO₃ electrolyte at 770° C. with a current density of 0.6 A/cm² using a stainless steel 304 carbon pot case as the anode and a 168 cm² area brass cathode. The magnification of the panels in FIG. 20 are: A: 6200×, B: 500×, C: 5,000×, D: 6,200×, E: 20,000×, or F: 110,000× magnification.

Panel A of FIG. 20 shows an SEM of a lower purity CNO product grown in the same electrolyte exhibiting a mix of CNT, CNO, and carbon nano-bamboos. Panels B through G show SEM of a product with higher purity CNO product. Electrolysis processes were conducted with sodium carbonate added as an alternative ternary component to the strontium/lithium binary mixture to probe alternative low lithium carbonate domains. A mix containing ⅓ Li₂CO₃, ⅓ SrCO₃, and ⅓ Na₂CO₃ was fully molten at 750° C., and at 750° C. a 4-hour electrolysis was conducted at 0.2 A/cm². The CNT product was a good quality, at 80-90% purity by inspection of the SEM, but not as high as the >>90% purity evident in the unitary Li₂CO₃ and binary Li₂CO₃/SrCO₃ electrolyte, as described hereinabove. However, as expected from the sodium-containing electrolysis potentials shown in FIG. 12, the electrolysis potential was 0.6 V higher when using sodium-containing electrolyte rather than the sodium-free electrolytes. A 45 wt % Li₂CO₃, 45% SrCO₃, 9 wt % Na₂CO₃ and 1% LiO₂ was again higher in voltage, and at 750° C. a 4-hour electrolysis at 0.4 A/cm² formed CNT product of good quality, at 85-90% purity.

A lower concentration of Na₂CO₃, along with a high concentration of SrCO₃ electrolyte did facilitate CNT formation, albeit at a lower quality. This 770° C. electrolysis at 0.6 A/cm² in 50%/45%/5% lithium/strontium carbonate produced 80% purity CNTs by SEM inspection. The addition of 1% strontium oxide consistently yielded an improved, good quality 85% purity CNT formation in 770° C. electrolytes at 0.4 or 0.6 A/cm² both in 40%/50%/9% and in 40%/54%/5% lithium/strontium/sodium carbonate electrolytes containing 1 wt % strontium oxide.

Interestingly as shown in FIG. 20, an electrolyte with a lower concentration of sodium carbonate can generate a product with a high-purity (i.e. high wt % or a high percentage of the constituent structures shown in the images of the product) of carbon nano-onion (CNO) as constituent carbon nanostructures, rather than a product with a high-purity of CNT as constituent carbon nanostructures. In a lithium electrolyte without other alkali or alkali earth cations, the inventors have previously demonstrated production of the carbon nano-onions; such as is in Li₂CO₃ containing concentrated (5.9 m) Li₂O₃. As seen in FIG. 20, CNOs were generated using a high strontium concentration electrolyte at 770° C. in a 54%/41%/5% lithium/strontium/sodium carbonate at 0.6 A/cm². The electrolysis (in the 3rd electrolysis run) generated a product with greater than 90% CNOs. The percent of CNOs the product grew from 35% CNO in the first electrolysis, to 65% CNO in the second electrolysis, and in the third electrolysis still in the same electrolyte, and at the same electrodes, to 95% purity CNO (as shown in FIG. 20 panels B-F). The third electrolysis product showed substantially less than 1% CNTs, as seen in panels B-F. A subsequent fourth electrolysis continued to yield similar high-purity CNOs. SEM of a run of the electrolyte batch that had lower CNO product, is shown in FIG. 20 Panel A, and exhibited a mixed CNT, CNO, and carbon nano-bamboo products indicating that the growth of the three products GNCs are interrelated. The high-purity CNO product was also observed using a 770° C. 65%/25%/10% lithium/strontium/sodium carbonate at 0.2 A/cm².

The product with a high purity of CNOs was also generated in the absence of sodium carbonate, when the electrolysis was perturbed, such as by lowering the cell temperature or by changing the electrolysis anode. For example, when the cell is lined with Nichrome A, the anode is made of Nichrome A (composition of 80% Ni and 20% chrome), rather than 304 stainless, and iron is then effectively excluded from the cell. Modifying and inhibiting transition metal nucleation can enhance CNO formation. Electrolysis in this Nichrome A anode cell at 770° C. electrolysis in a 75%/25% lithium/strontium carbonate at 0.2 A/cm² produced a product with 90% CNOs, by SEM inspection.

Without added oxide, a 50% strontium carbonate electrolyte containing barium 25% carbonate did not produce CNOs and <10% CNTs, as electrolyzed at 770° C. 25 wt % Li₂CO₃/50 wt % SrCO₃/25 wt % BaCO₃ at 0.6 A cm². An electrolyte containing both sodium carbonate and barium oxide, further increased the electrolysis potential by 0.1V and generated <50% lower quality purity CNTs at either 0.07, 10, 0.20, or 0.40 A/cm² in 40 wt % SrCO₃, 40 wt % Li₂CO₃, 15 wt % Na₂CO₃, and 5 wt % BaO electrolyte 775° C.

Example 18 relates to doping carbon nanostructures made with a low-lithium carbonate electrolyte

It is known that boron, added as borate salts to the lithium electrolyzed during molten carbonate electrolysis processes, can dope the CNT acting to increase the conductivity of the CNT product by an order of magnitude. Here, the addition of borax (Na₂B₄O₇·10H₂O) to a strontium-rich electrolyte was investigated to add boron and probe its effect on the purity of an electrolysis product. It is known that borax loses its water contents at temperatures greater than 602° C. Electrolytes were probed in x/y/z as _{Li2CO3} wt %/SrCO₃ wt %/borax wt % electrolytes. Electrolysis in both 75/24/1, 75/22/3, and 75/20/5 electrolytes for both 4 and 16 hours at 0.6 A/cm² in 800° C. yielded good quality CNTs by SEM analysis.

Example 19 relates to use of a low-lithium, strontium-containing carbonate electrolyte with a scaled-up electrode.

Electrolysis processes described herein above were studied using small or medium-sized Muntz brass cathodes. Specifically, the electrolysis processes in FIGS. 15, 16 and 18-20 were conducted using cathodes with a surface area under 200 cm², while the electrolysis that produced the product shown in FIG. 17 electrolysis utilized a cathode with an area of 1,600 cm². Strontium electrolyte electrolysis processes can be routinely performed with larger cathodes (and at higher current densities) to facilitate large-scale carbon capture.

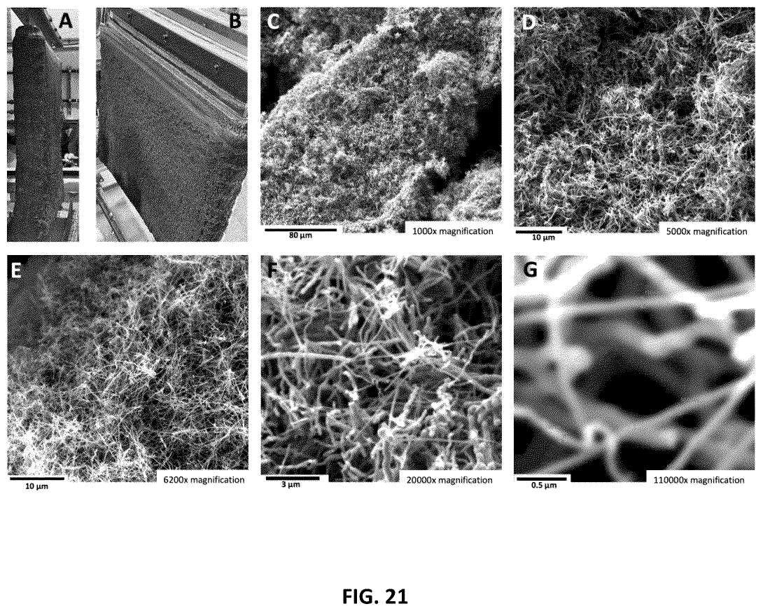

FIG. 21 shows the product of a 770° C. 50% SrCO₃ and 50% Li₂CO₃ 0.6 A/cm² current density electrolysis conducts at 770° C. and J=0.6 A/cm² utilizing the stainless steel 304 carbon pot case as the anode with an 11,000 cm² surface area Muntz brass cathode. The magnification of each SEM panel in FIG. 21 is as follows: C: 1,000×, D: 5000×, E; 6200×; F: 20,000×, G: 110,000×.

Panel A of FIG. 21 shows a photograph of the hot Muntz brass cathode subsequent to electrolysis as lifted from the electrolysis chamber below. Panel B of FIG. 21 shows a photograph of the same cathode subsequent to cooling. The cathode deposit is approximately 4″ thick. SEM characterization of the product of the high surface area, high current density 40% SrCO₃ electrolysis is seen in panels C-G of FIG. 21. Once again, a high-purity CNT product is attained, and as was seen in the other high-current density electrolysis product of FIG. 16, an increased tangling of the carbon nanotubes is also evident in the carbon nanotube containing product.

Note that the cathode in FIG. 21 is vertically oriented. This considerably decreases the physical plant footprint required for the molten carbonate electrolysis processes for decarbonization described herein.

Without being bound by any particular theory, lithium carbonate is less available than strontium carbonate, both due to its lower natural abundance and lithium carbonate's increasing EV and Li-ion battery demand. The high cost of lithium carbonate can be an impediment to the electrolytic processes described herein for molten carbonate decarbonization. Carbonate carbonization electrolytes prepared from concentrated strontium carbonate described herein are substantially more cost-effective than lithium-based electrolytes. The incompatibility of the high solidus point of SrCO₃ to the preferred molten carbonate decarbonization range of <800° C. has been overcome by determining that strontium carbonate is unusually soluble (to 65% at 790° C. in lithium carbonate. Ternary or higher carbonate mixed electrolytes may further decrease lithium concentration levels in the carbonate electrolyte. Thermodynamic equilibrium for the affinity of strontium carbonate to absorb and release carbon dioxide have been calculated, and are shown to be comparable to lithium carbonate, and substantially different than that of the other corresponding alkali and alkali earth carbonate equilibria.

The use of a low-lithium electrolyte that can provide an electrolyte melting point within the optimal process range for molten carbonate electrolytic conversion of CO₂ to GNC growth of between about 700° C. to about 850° C. has been investigated for concentrated strontium carbonate electrolytes. The electrochemical potential of molten carbonate electrolysis was investigated, and it is shown that the electrolysis potential is low in both pure lithium and binary strontium/lithium electrolytes, but higher in sodium or barium carbonate electrolytes.

Low-lithium electrolysis processes were performed using a vertical planar Monel, cathode and vertical anodes comprised of stainless steel or Nichrome. Effective high-concentration strontium demonstrated electrolytes which produce high-quality GNC products include both binary mixtures (for example, strontium/lithium carbonate or strontium oxide/lithium carbonate) and ternary mixture electrolytes (for example, strontium carbonate/lithium carbonate/strontium oxide or borate or sodium salts).

A high current density of 0.6 A/cm² is consistent with industrial-rate electrochemical processes. Binary and ternary strontium carbonate electrolytes were tested for CO₂ electrolytic decarbonization using an electrolysis temperature of 770° C., a high current density of 0.6 A/cm² and a low-lithium carbonate electrolyte comprising 64 wt % SrCO₃ and 35 wt % Li₂CO₃ with about 1 wt % SrO. This low-lithium carbonate electrolyte was among those demonstrated as effective for high-purity carbon nanotube electrosynthesis and that substantially decreased the concentration of lithium carbonated required within the electrolyte. This low-lithium carbonate electrolyte may also be effective for synthesizing a product with a high purity of CNOs using carbon dioxide as a source of carbon.

Example 19 relates to use of a ternary, low-lithium carbonate electrolyte with strontium borate

This example relates to use of a ternary, low-lithium carbonate electrolyte that comprises strontium borate to lower the lithium carbonate content of a CO₂ splitting electrolyte salt and to produce a product with high-quality CNTs.

The strontium borate was synthesized according to the general procedure of T. K. Seshagiri, et al., Spectroscopic studies of thulium doped strontium borate glass, J. Non-Crystalline Solids, 356, 1032-1036, the entire contents of which are incorporated herein by reference, which describes the following equation:

SrCO₃+4H₃BO₃->SrB₄O₇+6H₂O+CO₂ (EQN 9)

Stoichiometric ratios of reactants were used with 5% excess for acid boric. Specifically, 148 g SrCO₃ was mixed with 260 g of boric acid and then ground with a Magic Bullet Blender to decrease particle size and enhance uniformity. The mixture was then placed in a 600° C. kiln for about 4 hours at 600° C. and then cooled down to room temperature to produce a sintered sample. The sintered sample was then re-ground and placed in a 900° C. kiln overnight. The initial weight of powder was 408 g, after the first stage the mass was around 261 g and after the second treatment it was around 240 g, close to the theoretical yield of 242 g.

It was found that a simplified synthesis reaction can also be performed which prevents the evolution of water vapor by using B₂O₃ (Chemsavers Boron oxide, 99% pure) according to the following equation:

SrCO₃+2B₂O₃->SrB₄O₇+CO₂ (EQN 10)

An electrolysis process for splitting CO₂ was performed using three strontium borate ternary electrolytes. The electrolytes were composed of 10 wt % SrB₄O₇, and either (1) 60, (2) 55, or (3) 45 wt % SrCO₃ and either (1) 30, (2) 35, or (3) 45 wt % Li₂CO₃. The electrolytes were melted at 770° C. Each of these ternary melted strontium borate containing electrolytes appear to have a lower viscosity than the equivalent binary mix electrolyte without strontium borate.

The electrolysis process was conducted using three ternary borates at 770° C., applying an electrolysis current density of 0.6 A/cm² using a Muntz Brass cathode and the electrolysis case was made 304 stainless steel with the walls of the case serving as the anode.

The carbon product grew uniformly on each side of the cathode facing one or the other of the anode walls. Each of the electrolysis processes in the three ternary borate containing electrolytes formed a high-quality CNT product. SEM of the product made using the 10/45/45 wt % SrB₄O₇/SrCO₃/Li₂CO₃ electrolyte is shown in FIG. 21 with the following magnifications: panel A: 1,000×, panel B: 5,000×, panel C: 6,200×, panel D: 6,200×, panel E: 20,000 and panel F: 110,000× magnification. Boron oxide, B₂O₃ also maintains the same boron valence state B (+3), as SrB₄O₇. B₂O₃ also has a low melting point of 450° C. A similar effect to the ternary 10/55/35 wt % SrB₄O₇/SrCO₃/Li₂CO₃ electrolyte can be achieved with a ternary electrolyte mixture of 6/59/35 wt % B₂O₃/SrCO₃/Li₂CO₃ electrolyte. A quaternary electrolyte mixture, such as May 2, 1964/30 wt % B₂O₃/SrO/SrCO₃/Li₂CO₃ and other similar quaternary electrolytes are also of use. Similarly, an electrolyte mix of greater than 4 parts can further decrease the molten electrolyte viscosity of melting point.

Additionally, binary electrolyte mixes were previously prepared with 0, 1 or 3% SrB₄O₇ in Li₂CO₃. It had been previously observed that the electrical conductivity of CNTs prepared by electrolysis in 0% borate of 11,500 S/m was increased to 29,000 S/m when 2.9 wt % lithium borate, LiBO₃, was added to the electrolysis electrolyte.

A similar phenomenon of increased CNT electrical conductivity was observed when 1% or 3% SrB₄O₇, rather than lithium borate, was added to the electrolysis electrolyte. Note, the boron valence state, B (+3) remains the same in the added LiBO₂ and SrB₄O₇ salts. The 1% or 3% SrB₄O₇ CNT products have measured electrical conductivity of 19,100 and 27,600 S/m respectively. Conductivity was measured with a two-point probe (1.3 cm diameter plates) cell, under pressure to remove powder voids, and digital calipers used to measure thickness of the pressed powder between the plates, with a Teledyne 5 digit ohmmeter.

Example 20 relates to use of a low-lithium carbonate electrolyte that comprises beryllium

This example relates to a use of beryllium carbonate alone and in combination with alkali and alkali earth carbonates ability to act as a carbon capture agent.

When modelled, beryllium carbonate has a high capacity, carbon capture storage material. Carbon dioxide is stored in beryllium carbonate and is released in the reaction to CO₂ and beryllium oxide:

BeCO₃ [symbol] CO₂+BeO (EQN 11)

Amines are well known carbon capture absorbents and have been used in liquid form or are affixed to membranes to bind CO₂. Typically, the CO₂ is bound at a lower temperature and released in concentrated form at a higher temperature. Repeat low temperature binding and higher temperature release cycles are used to capture CO₂. Amino acids, amines and ionic liquids have also been utilized in temperature (or pressure) cycles to capture dilute CO₂ and release concentrated CO₂. Similarly, calcium carbonate is reversibly calcinated as a dry powder to calcium oxide, or as precipitated from an aqueous hydroxide solution has been used to capture dilute CO₂ at a lower temperature and, upon heating, release concentrated CO₂. Molten carbonate solutions have also been used to capture CO₂ with calcium oxide, reversibly forming calcium carbonate in the molten salt. Rather than just concentrating the CO₂, this process also stores this captured greenhouse gas by transforming it to solid carbon (and releasing the O₂ from the capture CO₂).

In Table 2, the various capacity of CO₂ captured, in typical units of kg CO₂ captured per kg absorbent, are compiled for common absorbents in the last column. The capacities are will be lower than those compiled when a matrix (such as an inert membrane or solvent stabilizer) is required as an additional mass component in the CO₂ carbon capture process. In order of increasing capacity, the absorbents are ionic liquids<amino acids & amines<calcium oxide (to calcium carbonate).

Table 2. The high carbon storage capacity of beryllium carbonate, sources: (1) S. Y. W. Chai, et al., Review of carbon capture absorbents for CO₂ utilization, Greenhouse Gas Sci. Technol., 2022, 12, 394-427; (2) S. Licht, Efficient solar-driven synthesis, carbon capture and desalinization, STEP, Advanced Materials, 2011, 23, 5592-5612; (3) J. Ren et al., Recent advances in solar thermal electrochemical process (STEP) for carbon neutral products and high value nanocarbons, Accounts of Chemical Research, 2019, 52, 3177-3187.

| | | | | | Average | | |
|---|---|---|---|---|---|---|---|
| | | | | | Capacity, | | Capacity, |
| | | | | CO₂ | mol CO₂/ | | kg CO₂/ |
| | | | Formula | Storage | mol | | kg |
| Chemical absorbent/product | Acronym | Formula | Weight | Mechanism | absorbent | Source | absorbent |
| 1-Butyl-3-methylimidazolium | [Bmim][Tf₂N] | C₁₀H₁₅F₆N₃O₄S₂ | 419.37 | ionic liquid | 0.68 | 1 | 0.07 |
| bis(trifluoromethylsulfonyl)imide | | | | absorbent | | | |
| 1-aminopropyl-3- | APMim[BF4] | C₇H₁₄N₃BF₄ | 227.01 | ionic liquid | 0.34 | 1 | 0.07 |
| methylimidazolium | | | | absorbent | | | |
| tetraborafluorate/various | | | | | | | |
| products | | | | | | | |
| 1-Butyl-3-methylimidazolium | [Bmim][PF₆] | C₈H₁₅F₆N₂P | 284.186 | ionic liquid | 0.51 | 1 | 0.08 |
| hexafluorophosphate/“” | | | | absorbent | | | |
| products | | | | | | | |
| 1-Butyl-3-methylimidazolium | [Bmim][BF₄] | C₈H₁₅BF₄N₂ | 226.03 | ionic liquid | 0.44 | 1 | 0.09 |
| tetrafluoroborate/various | | | | absorbent | | | |
| products | | | | | | | |
| Taurine to protonated acid, | | C₂H₇NO₃S | 125.14 | amino acid | 0.7 | 1 | 0.25 |
| HCO₃⁻ or carbamate | | | | absorbent | | | |
| Proline to protonated acid, | | C₅H₉NO₂ | 115.132 | amino acid | 0.7 | 1 | 0.27 |
| HCO₃⁻ or carbamate | | | | absorbent | | | |
| Glycine to protonated acid, | | C₂H₅NO₂ | 75.067 | amino acid | 0.6 | 1 | 0.35 |
| HCO₃⁻ or carbamate | | | | absorbent | | | |
| monoethanolamine to | MEA | C₅H₁₃NO₂ | 61.08 | amine | 0.5 | 1 | 0.36 |
| RNHCOO⁻ | | | | absorbent | | | |
| diethanolamine to RNHCOO⁻ | DEA | C₄H₁₁NO₂ | 105.14 | amine | 0.5 | 1 | 0.21 |
| | | | | absorbent | | | |
| methyldiethanolamine to ‘’”” | MDEA | C₅H₁₃NO₂ | 119.164 | amine | 1 | 1 | 0.37 |
| | | | | absorbent | | | |
| diethylethanolamine to “” | DEAE | C₆H₁₅NO | 117.192 | amine | 0.5 | 1 | 0.19 |
| | | | | absorbent | | | |
| calcium oxide to carbonate | | CaO | 56.08 | CaO + CO₂ −> | 1 | 2 | 0.78 |
| | | | | CaCO₃ | | | |
| lithium oxide to carbonate | | Li2O | 29.88 | Li₂O + CO₂ −> | 1 | 3 | 1.47 |
| | | | | Li₂CO₃ | | | |
| beryllium oxide to carbonate | | BeO | 24.01 | BeO + CO₂ −> | 1 | | 1.83 |
| | | | | BeCO₃ | | | |

The lithium carbonate/lithium oxide was introduced as amongst the highest carbon capture materials as delineated in the last row of Table W with a storage capacity of 1.46 kg CO₂ per kg Li₂O. Under argon gas, Li₂CO₃ entirely dissociates to CO₂+Li₂O (L. Shi, et al., Process of thermal decomposition of lithium carbonate, in monograph Materials Processing Fundamentals, Springer International, 2020, ISBN: 9783030365561). Under even small partial pressures of CO₂, such as the 426 ppm (and rising) of CO₂ in the air, Li₂CO₃ only fractionally dissociates to CO₂, attaining a concentration of 0.3 molal Li₂O per kg (J. Ren et al., The minimum electrolytic energy needed to convert carbon dioxide to carbon by electrolysis in carbonate melts, J. Phys. Chem. C, 2019, 52, 3177-3187). This high capacity was experimentally realized in the form of the electrolytic splitting of CO₂ in molten Li₂CO₃. The small concentration of dissolved lithium oxide sustained in molten lithium carbonate under air is sufficient to support high CO₂ splitting electrochemical current and continuous renewal of the molten Li₂CO₃ electrolyte.

Beryllium carbonate is introduced as an even lower molecular weight (per carbon dioxide stored) salt. With a melting point of 54° C., BeCO₃ has the lowest melting point, by over 300° C., of any combination of other alkali or alkali earth carbonates. Beryllium carbonate is less prevalent as a salt than lithium or strontium carbonate, and its oxide under certain circumstances has a higher toxicity. However, the storage of CO₂ by BeCO₃ serves as a model towards amongst the highest carbon storage capacity materials. Additionally, it is shown that BeCO₃ can lower the melting point of other alkali/alkali earth carbonates.

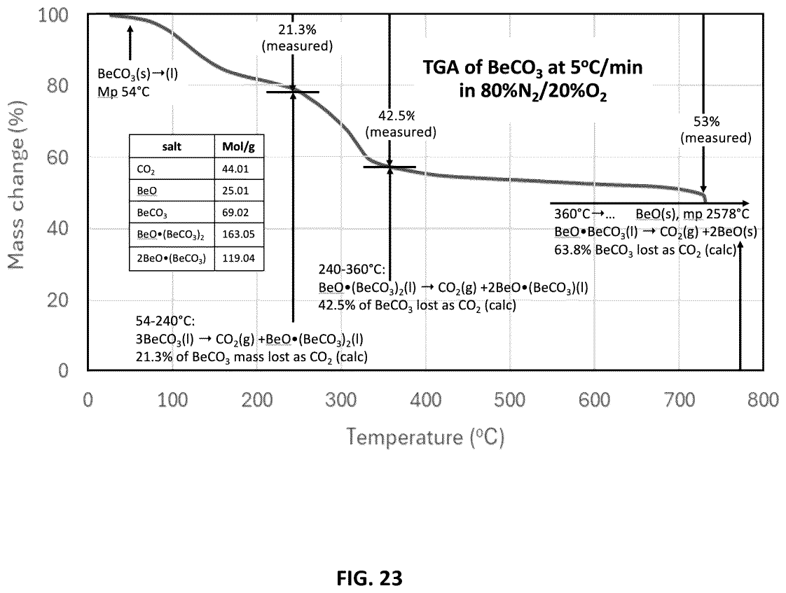

FIG. 23 presents the TGA results of beryllium carbonate conducted starting from 30° C., with a 5° C. temperature increase per minute, and under an 80% N₂/20% O₂ gas mix. In addition, FIG. 23 includes a first interpretation of that TGA. Salts in the liquid, as opposed to solid form, facilitate the rapid release of CO₂ and act as an indicator of the melting point of that salt. In the figure, the known 54° C. melting of BeCO₃ is shown. The mass loss and temperature is noted at the start of rapid declines, and a consistent mechanism of CO₂ mass loss is determined by calculating consistent chemical formulas of calcinated beryllium oxide and beryllium carbonate salts. As seen in FIG. 23, the BeCO₃ evolves CO₂ to become BeO·(BeCO₃)₂ from about 54° C. to about 240° C. It then evolves CO₂ to become 2BeO·(BeCO₃) from about 240° C. to about 360° C. Finally, it then evolves CO₂ to become BeO from about 360° C. onward. Note, that a range of BeO and BeCO₃ admixtures comprises xBeO·y(BeCO₃), including x=0.

The low-lithium carbonate electrolytes made as a mixture of strontium carbonate or strontium oxide are substantially less expensive than comparable lithium-carbonate based electrolytes. The use of an electrolyte that is a binary mixture (for example, strontium carbonate/lithium carbonate or strontium oxide/lithium carbonate) and/or an electrolyte that is a ternary mixture (for example, strontium/sodium/lithium carbonate) and that can provide an electrolyte melting point within the optimal range for CO₂ to carbon nanomaterial growth of between about 700° C. to about 850° C. is preferred. Low-lithium carbonate electrolysis may be performed using a planar, rather than a coiled, and brass, rather than Monel, cathode without substantially affecting low-lithium CNT growth

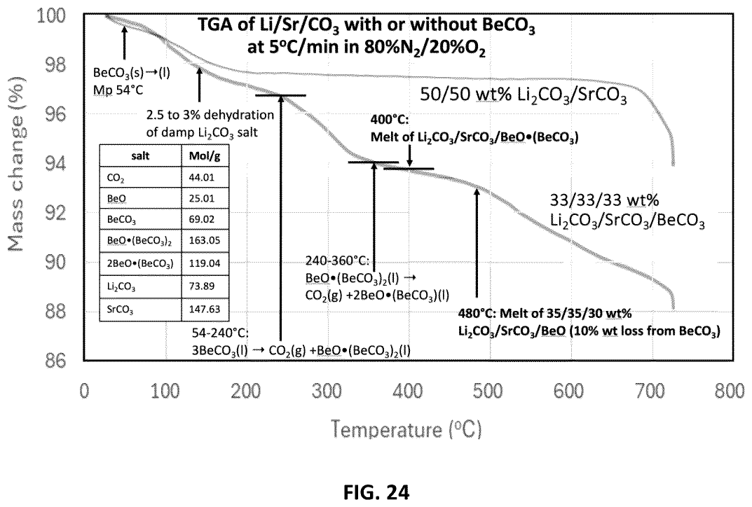

While SrCO₃ has a melting point of 1194° C., a binary mix of SrCO₃ and Li₂CO₃ has a melting point of 690° C. to 790° C., as the weight percent of SrCO₃ in the binary mix increases from 40 to 65%. FIG. 24 demonstrates that the melting point is further substantially decrease by inclusion of BeCO₃ in a ternary mix. Specifically, FIG. 24. compares the TGA's of a binary mix 50/50 wt % Li₂CO₃/SrCO₃ to that of a ternary mix composed one third by weight each in Li₂CO₃, SrCO₃, BeCO₃ conducted starting from 30° C., with a 5° C. temperature increase per minute, and under an 80% N₂/20% O₂ gas mix. In the TGA of the binary mix of 50/50 wt % Li₂CO₃/SrCO₃ a few percent weight loss is evident at low temperature as the damp material dries, then the mass is moderately constant, decreasing slowly, until a rapid weight loss occurs around the 690° C. melting point observed for a Li₂CO₃/SrCO₃ mixture. Alternatively, in addition to the low temperature drying, the 33/33/33 wt % Li₂CO₃/SrCO₃/BeCO₃ ternary mix exhibits the hallmarks of pure BeCO₃ up to a temperature of 360° C. However, in addition, two other sharper decreases in mass loss are observed starting at 400° C. and at 460° C. These are attributed to the melting point of new lower melting ternary mixes of Li₂CO₃/SrCO₃/BeO (BeCO₃) 2 and specifically of 35/35/30 wt % Li₂CO₃/SrCO₃/BeO. Hence, through the inclusion of BeCO₃, an inorganic carbonate mix can have a lower melting point than the mix without BeCO₃. Similarly, a carbon dioxide capture compound can include a binary, ternary, quaternary or higher component mix of beryllium carbonate or beryllium oxide with other alkali or alkali earth carbonates, or salts with which include the column 4, 5, 6 or 7 elements can affect the melting point of beryllium compounds used as a carbon dioxide capture and release compound.

1-39. (canceled)

40. A method for producing a graphene nanocarbon (GNC) product comprising:
(a) heating a low-lithium carbonate electrolyte to obtain a molten carbonate electrolyte, the low-lithium carbonate electrolyte comprising a strontium salt present in greater than 30% of a total weight of the electrolyte (wt %);
(b) positioning the molten carbonate electrolyte between an anode and a cathode in an electrolytic cell;
(c) applying an electrical current to the cathode and the anode in the electrolytic cell; and,
(d) collecting a carbon nanomaterial (GNC) product from the cathode.

41. The method of claim 40, further comprising a step of employing one or more GNC facilitation elements, wherein the one or more GNC facilitation elements are: (i) enhancing transition metal nucleation, ii) adding one or more defect inducing agents, (iii) reducing or removing an electrolyte conductivity impediment element, and (iv) any combination thereof.

42. The method of claim 40, wherein the strontium salt comprises; a strontium salt of carbonate, oxide, peroxide, superoxide, borate, sulfate, nitrate, phosphate, halide, halite or perhalate; a strontium Group 5 salt; a strontium Group 6 salt; a strontium Group 7 salt or any combination thereof and wherein the low-lithium carbonate electrolyte further comprises boric acid, boric oxide, a borate salt or any combination thereof.

43. The method of claim 40, wherein the strontium salt comprises: an alkali salt of carbonate, oxide, peroxide, superoxide, borate, sulfate, nitrate, phosphate, halide, halite or perhalate; an alkali Group 5 salt; an alkali Group 6 salt; an alkali Group 7 salt; a non-strontium alkali earth salt of carbonate, oxide, peroxide, superoxide, borate, sulfate, nitrate, phosphate, halide, halate, or perhalate; a non-strontium alkali earth Group 5 salt; a non-strontium alkali earth Group 6 salt; a non-strontium alkali earth Group 7 salt or any combination thereof and wherein the low-lithium carbonate electrolyte further comprises boric acid, boric oxide, a borate salt or any combination thereof.

44. The method of claim 40, wherein the low-lithium carbonate electrolyte further comprises boric acid, boric oxide, a borate salt or any combination thereof.

45. The method of claim 40, wherein the low-lithium carbonate electrolyte comprises a non-lithium alkali carbonate, an alkali earth carbonate and any combination thereof.

46. The method of claim 40, wherein the low-lithium carbonate electrolyte is one of a binary mixture, a ternary, a quaternary mixture, or a mixture of greater than 4 components.

47. The method of claim 40, wherein the low-lithium carbonate electrolyte comprises an amount of lithium that is greater than about 5% on a weight basis (wt %) and less than 100% wt %.

48. The method of claim 47, wherein the lithium is present as: lithium carbonate, lithium oxide, lithium chloride, lithium bromide, lithium iodide, lithium silicate, lithium nitrate, lithium sulfate, lithium phosphate, lithium borate or any combination thereof.

49. The method of claim 41, wherein the step of adding one or more defect inducing agents comprises a step of introducing one or more oxides into the low-lithium carbonate electrolyte, or adding one or more foreign adatoms, or one or more substitutional impurities or any combination thereof.

50. The method of claim 49, wherein the one or more oxides is strontium oxide, barium oxide, beryllium oxide, sodium oxide, calcium oxide, iron oxide, cobalt oxide, lithium oxide or alkali oxide, an other than strontium alkali earth oxide, a metal oxide, a non-metal oxide and any combination thereof.

51. The method of claim 49, wherein the one or more oxides are introduced into the molten carbonate electrolyte by oxidizing the anode.

52. The method of claim 41, wherein the one or more transition metal nucleation agents comprise adding a transition metal salt to the low-lithium carbonate electrolyte.

53. The method of claim 52, wherein the transition metal salt is one or more of a salt that comprises: nickel, iron, chromium, nickel, copper, manganese, titanium, zirconium, molybdenum, tantalum, tungsten, silver, cadmium, tin, ruthenium, vanadium, cobalt or any combination thereof.

54. The method of claim 41, wherein the step of removing the electrolyte conductivity impediment element comprises decreasing a current density of the electrical current.

55. (canceled)

56. The method of claim 40, wherein the low-lithium carbonate electrolyte exhibits an equilibrium constant to bind and release CO₂ comparable to that of lithium carbonate.

57. The method of claim 40, further comprising a step of adding an oxidative agent to induce structural defects within the GNC product.

58. The method of claim 40, further comprising a step of introducing a nanomaterial selection component in the electrolytic cell, wherein the nanomaterial selection component selects for the GNC product to comprise a desired purity of one or more of carbon nanotubes (CNT), carbon nanofibers (CNF), carbon platelets, graphene, solid carbon nano-onions, hollow carbon nano-onions, conical CNFs, nano-bamboos, nano-pearls, Ni-coated CNTs, nano-flowers, nano-dragons, nano-rods, nano-belts, nano-trees, nano-scaffolds, or nano-helices.

59. (canceled)

60. (canceled)

61. The method of claim 40, further comprising a step of introducing a doping component for making a doped GNC product.

62. The method of claim 40, further comprising a step of introducing a magnetic additive component for making a magnetic GNC product.
